(19) United States
(12) Patent Application Publication
(10) Pub. No.: US 2016/0280849 A1
(43) Pub. Date: Sep. 29, 2016

(54) POLYMER PRODUCT AND PRODUCTION METHOD THEREOF, AND MOLDED PRODUCT

(71) Applicants: Yasuo KAMADA, Shizuoka (JP); Taichi NEMOTO, Shizuoka (JP); Yoko ARAI, Shizuoka (JP); Satoshi IZUMI, Shizuoka (JP)

(72) Inventors: Yasuo KAMADA, Shizuoka (JP); Taichi NEMOTO, Shizuoka (JP); Yoko ARAI, Shizuoka (JP); Satoshi IZUMI, Shizuoka (JP)

(21) Appl. No.: 15/035,789

(22) PCT Filed: Nov. 18, 2014
(86) PCT No.: PCT/JP2014/080997

§ 371 Date: May 11, 2016

(30) Foreign Application Priority Data
Nov. 20, 2013 (JP) 2013-240383
Apr. 1, 2014 (JP) 2014-075227

(51) Int. Cl. C08G 63/78; C08J 5/18; C08G 63/08

(52) U.S. Cl. CPC C08G 63/78; C08G 63/08; C08J 5/18; C08J 2367/04; C08G 2230/00

(57) ABSTRACT

Provided is a polymer product having a branched chain made of polyester, and a weight average molecular weight of 200,000 or greater when measured by gel permeation chromatography.

### TECHNICAL FIELD

The present invention relates to a polymer product and a polymer product production method, and a molded product.

### BACKGROUND ART

General-purpose resins made from petroleum such as polyethylene, polypropylene, polyvinyl chloride, and polystyrene are used in various fields including daily goods, home appliances, automobile parts, building materials, and food packaging, because they have such properties as a light weight, favorable machining properties, physical properties, and durability.

However, the favorable durability of these resin products becomes a disadvantage when they are disposed of after used. They have a poor degradability to the nature and may give impacts to the biogeocenosis.

To solve this problem, extensive development is currently being made into biodegradable polyesters, of which starting materials are recyclable resources, and of which representative example is a polylactic acid which is a thermoplastic resin and has biodegradability.

As a method for producing biodegradable polyesters by polymerization, for example, a polylactic acid is produced by ring-opening-polymerizing lactide, which is a representative example of ring-opening-polymerizable monomers. Examples of known methods for producing a polymer by ring-opening-polymerizing such a ring-opening-polymerizable monomer include a melt polymerization method of reacting a ring-opening-polymerizable monomer in a melted state, and a solution polymerization method of polymerizing a ring-opening-polymerizable monomer in an organic solvent.

Most of these biodegradable polyesters being planned for practical use are straight-chain polymers made of combination of a hydroxyfatty acid or a dicarboxylic acid and a diol. Among them, a polylactic acid is paid attention as a substitute for existing petroleum-derived plastics, because the mechanistic strength of a polylactic acid shows a behavior close to that of the existing plastics.

However, under the current circumstances, biodegradable polyesters can have only limited applications, because they have a poor variety of monomer structures, and insufficient strength and heat resistance. For example, a polylactic acid has a drawback of having a high crystallinity and being brittle among biodegradable polyesters, and is limited to the field of hard molded products. If it was molded into a film or the like, it would lack in flexibility or have a problem of whitening when folded. Therefore, it is not used in the field of soft or semihard products. For these reasons, biodegradable polyesters have limited applications as long as they are used alone.

Hence, blending with other polymers and use of various reforming agents are being considered.

However, to take full advantage of properties (carbon neutrality and easy degradability) of biodegradable polyesters, it is strongly demanded that these additives be also bio-based materials.

For example, there is developed a branched polyester reforming agent that takes advantage of the molecular structure of a multifunctional hydroxycarboxylic acid having a plurality of functional groups having different reactivities, such as a glyceric acid. Specifically, there is developed a method of adding a polyglyceryl fatty acid ester derivative made of a botanical resource-derived substance to a polylactic acid (see, e.g., PTL 1). Further, there is developed a polylactic acid-based additive having a branched structure, obtained by incorporating a botanical resource-derived multifunctional castor oil derivative or the like to a polylactic acid chain (see, e.g., PTL 2).

However, according to the above method, it is only possible to obtain low molecular weight polymers having a weight average molecular weight of from about 2,000 to 40,000. Problems of such polymer products are a poor durability and a low softening temperature. Another problem is that when formed into a film, they may be broken because of their low molecular weight.

The reason why it is only possible to obtain low molecular weight polymers is that during melt polymerization, the viscosity of branched polymers increases and makes it harder for the molecular chains to elongate from the polymer terminals.

In polymerization of a trifunctional or higher monomer, if the additive amount of the monomer is low, a satisfactory branched structure cannot be obtained because branching efficiency per molecule is low. If the additive amount of the monomer is high, an unmelted gel product may be produced because the monomer tends to cross-link three-dimensionally. In order to suppress production of such a gel product, it is being considered to use a multifunctional chain transfer agent in combination to thereby prevent gelation and increase the amount of branches to be incorporated. However, it is very difficult to achieve anti-gelation and a high molecular weight simultaneously.

Further, as an attempt to obtain a high molecular weight polymer by polymerizing a ring-opening-polymerizable monomer, there is proposed a method of melting and ring-opening-polymerizing lactide in an organic solvent (see, e.g., PTL 3).

According to the proposed method, D-lactide is polymerized in a dichloromethane solution, which results in a straight-chain poly-D-lactic acid having a molecular weight of 200,000 or greater, at a polymer conversion rate of 99.4%.

In order to obtain a branched polymer having a high molecular weight by polymerization in an organic solvent, it is necessary to suppress the viscosity of the branched polymer by adding the organic solvent in an amount greater than necessary in the case of a straight-chain polymer. However, by solution polymerization, the weight average molecular weight of the obtained polymer has improved to only 15,000 (see, e.g., PTL 4).

There is also proposed a technique of using a specific catalyst in order for a polylactic acid having a branched structure to be obtained at a low temperature (see, e.g., PTL 5). However, according to the proposed technique, the viscosity of the material increases and the material solidifies as the reaction advances, resulting in a monomer residual ratio of several % when no refining operation is performed. Furthermore, the weight average molecular weight of the obtained polymer measured by GPC in a THF solvent is 160,000 at a maximum.

Hence, it is currently requested to provide a polymer product that has a branched structure and a high molecular weight, and has a high flexibility, a high toughness, and a high strength. It is also preferable that such a polymer product be free from an organic solvent in terms of safety.

### CITATION LIST

### Patent Literature

PTL 1 Japanese Patent Application Laid-Open (JP-A) No. 2008-069299

PTL 2 JP-A No. 2009-024058

PTL 3 JP-A No. 2009-001614

PTL 4 JP-A No. 2012-177011

PTL 5 JP-A No. 2011-252102

### SUMMARY OF INVENTION

### Technical Problem

The present invention aims to solve the conventional problems described above and achieve the following object. That is, an object of the present invention is to provide a polymer product that has a high flexibility, a high toughness, and a high strength.

### Solution to Problem

Means for solving the problems described above is as follows.

A polymer product of the present invention has a branched chain made of polyester, and a weight average molecular weight of 200,000 or greater when measured by gel permeation chromatography.

### Advantageous Effects of Invention

According to the present invention, it is possible to provide a polymer product that can solve the conventional problems described above, and has a high flexibility, a high toughness, and a high strength.

### BRIEF DESCRIPTION OF DRAWINGS

FIG. 1 is a phase diagram showing states of a substance with respect to temperature and pressure, where Pc represents a critical pressure, and Tc represents a critical temperature.

FIG. 2 is a phase diagram defining a range of a compressive fluid, where Pc represents a critical pressure, and Tc represents a critical temperature.

FIG. 3 is a system diagram showing an example of a continuous polymerization step.

FIG. 4 is a system diagram showing an example of a continuous polymerization step.

FIG. 5A is an exemplary diagram showing a production system used in a first method.

FIG. 5B is an exemplary diagram showing a production system used in a first method.

FIG. 6 is an exemplary diagram showing a production system used in a second method.

FIG. 7 is a system diagram showing an example of a batch polymerization step.

FIG. 8 is a system diagram showing an example of a batch polymerization step.

### DESCRIPTION OF EMBODIMENTS

### Polymer Product and Production Method Thereof

A polymer product of the present invention has a branched chain made of polyester, and a weight average molecular weight of 200,000 or greater when measured by gel permeation chromatography.

A polymer product production method of the present invention includes at least a polymerization step, and further includes other steps according to necessity.

The polymer product production method is a method for producing the polymer product of the present invention.

In the polymerization step, at least a multifunctional initiator, a ring-opening-polymerizable monomer, and a compressive fluid are brought into contact with one another, to thereby ring-opening-polymerize the ring-opening-polymerizable monomer.

In the polymerization step, it is preferable to increase the density of the compressive fluid in the reaction system during the polymerization. The ratio of increase of the density is not particularly limited, and may be appropriately selected according to the purpose. However, if the monomer is diluted excessively, it becomes harder for the polymerization to advance. Therefore, it is preferable to increase the density to from 1.3 to 5 times as high as the density of the compressive fluid in the reaction system before the increase, and it is more preferable to increase the density to from 1.3 to 2 times as high as that.

The present inventors have conducted earnest studies, and found it possible to obtain a polymer having a drastically high molecular weight, by increasing the density of a compressive fluid (e.g., supercritical carbon dioxide) during polymerization of a monomer using the compressive fluid, and thereby greatly suppressing the viscosity of the polymer to be obtained. The present inventors have also made it possible to provide a branched polyester having a high molecular weight without using an organic solvent, by adding a polyhydric alcohol in a small amount as an initiator to thereby suppress gelation in an unmelted state, and by utilizing a plasticization effect and a viscosity suppression effect of a compressive fluid (e.g., supercritical carbon dioxide) to thereby suppress increase in the viscosity due to increase in the molecular weight.

The branched chain made of polyester described above can be paraphrased as a branched polyester (a polyester having branched chain). The branched polyester is one kind of branched polymers.

In the present invention, a branched polymer means a polymer having a branched structure, and to be more specific, a polymer having a multibranched structure. Examples of branched structures include: a star polymer having a plurality of straight-chain segments extending radially from the center core; a graft polymer having a polymer to be branched chains incorporated at multiple branching points present on the trunk straight polymer chain; a hyper branch polymer branched three-dimensionally and having branched structures in repeating units; and a dendrimer of which molecular weight distribution and branching degree are controlled precisely. One of these branched polymers may be used alone, or two or more of these may be used in combination.

The average branching degree of the polymer product is not particularly limited, and may be appropriately selected according to the purpose. However, it is preferably 2.1 or greater, and more preferably 2.5 or greater, and particularly preferably 3.0 or greater. When the average branching degree is less than 2.1, the branching degree of the polymer product may be low to degrade the flexibility.

### <Method for Calculating Average Branching Degree>

The average branching degree of the polymer product is calculated as follows.

$$\begin{matrix}Bu = NOH \text{/} {N}^{′} \\ = ( OHV \times {10}^{- 3} \text{/} 56.1 ) \text{/} ( 1 \text{/} Mn ) \\ = OHV \times Mn \times {10}^{- 3} \text{/} 56.1\end{matrix} \qquad Formula ( 1 )$$

In the formula (1), Bu represents an average branching degree, NOH represents the number of hydroxyl groups per 1 g of branched polyester, N′ represents the number of molecules per 1 g of branched polyester, Mn represents a number average molecular weight, OHV represents a hydroxyl value of branched polyester, and 56.1 represents the molecular weight of potassium hydroxide.

An average branching degree Bu of 2.0 means that all polyesters are straight-chain polyesters. An average branching degree Bu of greater than 2.0 means that the ratio of branched polyesters is high.

### <<Hydroxyl Value of Polymer Product>>

The hydroxyl value of the polymer product can be measured according to a method compliant with JIS K 0070.

### <Weight Average Molecular Weight>

The weight average molecular weight (Mw) of the polymer product measured by gel permeation chromatography is 200,000 or greater, preferably 300,000 or greater, and more preferably 400,000 or greater. When the weight average molecular weight is less than 200,000, mechanical strength will be insufficient. The upper limit of the weight average molecular weight (Mw) is not particularly limited, but is preferably 1,000,000 or less, and more preferably 600,000 or less, in terms of moldability. A method for measuring the weight average molecular weight of the polymer product may be the method described in the Examples to be described later.

### <Molecular Weight Distribution>

The molecular weight distribution (Mw/Mn) of the polymer product, obtained by diving the weight average molecular weight (Mw) thereof by the number average molecular weight (Mn) thereof is not particularly limited, and may be appropriately selected according to the purpose. However, it is preferably from 1.0 to 2.5, and more preferably from 1.2 to 2.0. When the molecular weight distribution (Mw/Mn) is greater than 2.5, the ratio of low molecular weight components will be high, which may degrade mechanical strength.

### <<Method for Measuring Molecular Weight>>

The weight average molecular weight and the number average molecular weight can be measured by a gel permeation chromatography (GPC) method, under the following conditions, for example.
Instrument: GPC-8020 (manufactured by Tosoh Corporation)
Columns: TSK G2000HXL and G4000HXL (manufactured by Tosoh Corporation)
Temperature: 40° C.
Solvent: chloroform
Flow rate: 0.5 mL/minute

A molecular weight distribution of the polymer product is measured under the conditions described above by injecting a sample having a concentration of 0.5% by mass (1 mL). The number average molecular weight (Mn) and the weight average molecular weight (Mw) of the polymer product are calculated from the obtained molecular weight distribution, using a molecular weight calibration curve generated based on a monodisperse polystyrene standard sample. The molecular weight distribution to be obtained is a value obtained by dividing Mw by Mn.

### <Monomer>

A monomer used as the material of the polymer product is not particularly limited, and an arbitrary monomer may be selected according to the purpose. However, a ring-opening-polymerizable monomer is preferable.

An arbitrary ring-opening-polymerizable monomer may be selected according to the purpose. However, a ring-opening-polymerizable monomer having a carbonyl group in the ring thereof is preferable. A carbonyl group is a π-bond between oxygen having a high electronegativity and carbon. In a carbonyl group, oxygen is polarized negatively by attracting a π-bonding electron, and carbon is polarized positively. Therefore, a carbonyl group has a high reactivity. When the compressive fluid is carbon dioxide, it is estimated that affinity between carbon dioxide and a polymer product to be produced will be high, because the structure of a carbonyl group is similar to that of carbon dioxide. These effects enhance the effect of the compressive fluid of plasticizing the produced polymer. The ring-opening-polymerizable monomer having a carbonyl group in the ring thereof is more preferably a ring-opening-polymerizable monomer having an ester bond (a ring-opening-polymerizable cyclic ester).

Examples of the ring-opening-polymerizable monomer include a cyclic ester.

### —Cyclic Ester—

The cyclic ester (ring-opening-polymerizable cyclic ester) is not particularly limited, and an arbitrary cyclic ester may be selected according to the purpose. However, a cyclic dimer obtained by allowing an L-form, a D-form, or both of a compound represented by General Formula (1) below to undergo dehydration condensation is preferable.

R—C*—H(—OH)(—COOH) General Formula (1)

In General Formula (1) above, R represents an alkyl group having 1 to 10 carbon atoms, and “C*” represents asymmetric carbon.

Examples of the compound represented by General Formula (1) above include an enantiomer of a lactic acid, an enantiomer of 2-hydroxybutanoic acid, an enantiomer of 2-hydroxypentanoic acid, an enantiomer of 2-hydroxyhexanoic acid, an enantiomer of 2-hydroxyheptanoic acid, an enantiomer of 2-hydroxyoctanoic acid, an enantiomer of 2-hydroxynonanoic acid, an enantiomer of 2-hydroxydecanoic acid, an enantiomer of 2-hydroxyundecanoic acid, and an enantiomer of 2-hydroxydodecanoic acid. Among these, an enantiomer of a lactic acid is particularly preferable in terms of reactivity and easy availability.

Examples of the cyclic ester include aliphatic lactone. Examples of the aliphatic lactone include β-propiolactone, β-butyrolactone, γ-butyrolactone, γ-hexanolactone, γ-octanolactone, δ-valerolactone, δ-hexanolactone, δ-octanolactone, ε-caprolactone, δ-dodecanolactone, α-methyl-γ-butyrolactone, β-methyl-δ-valerolactone, mevalonolactone, glycolide, lactide, and p-dioxanone. Among these, ε-caprolactone is particularly preferable in terms of reactivity and easy availability.

### <Compressive Fluid>

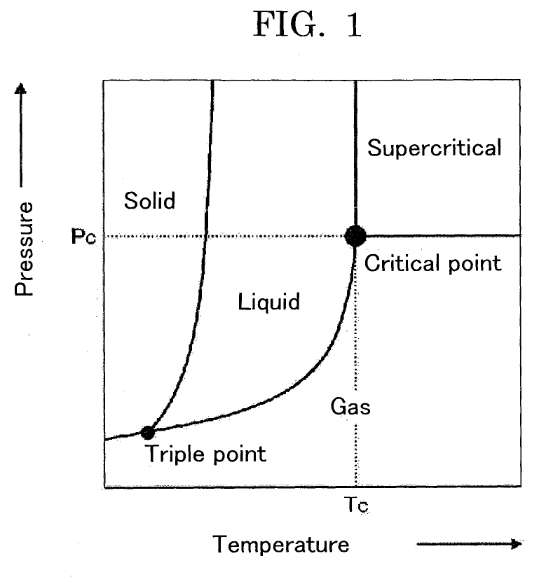

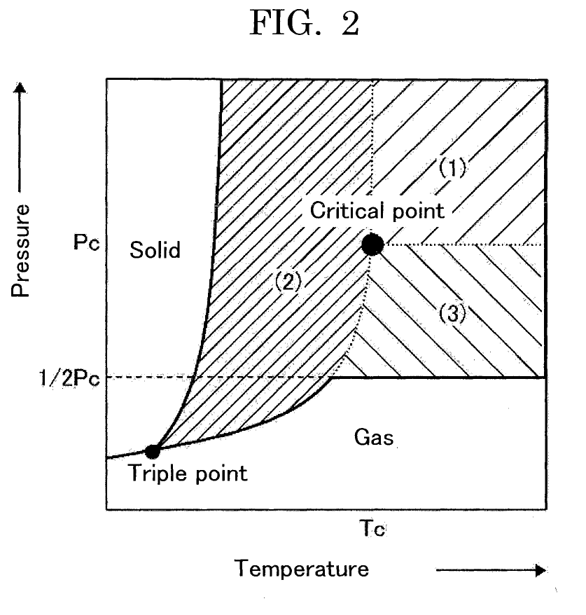

The compressive fluid will be explained with reference to FIG. 1 and FIG. 2. FIG. 1 is a phase diagram showing states of a substance with respect to temperature and pressure. FIG. 2 is a phase diagram defining the range of the compressive fluid.

The “compressive fluid” means a fluid that is in a state which appears when it is present in any of the regions (1), (2), and (3) shown in FIG. 2 in the phase diagram shown in FIG. 1.

In such regions, a substance is known to become a very dense state and show a behavior different from when it is at normal temperature and normal pressure. When a substance is in the region (1), it is a supercritical fluid. A supercritical fluid means a fluid that exists as a non-condensable high-density fluid in a temperature/pressure range above a limit (a critical point) until which a gas and a liquid can coexist, and that is not condensed when compressed. When a substance is in the region (2), it is a liquid. However, in the present invention, a substance in this region means a liquefied gas obtained by compressing a gaseous substance at normal temperature (25° C.) and normal pressure (1 atm). When a substance is in the region (3), it is a gas. In the present invention, a substance in this region means a high-pressure gas of which pressure is ½ of a critical pressure (Pc) or higher, i.e., (½Pc) or higher.

Examples of a constituent material of the compressive fluid include carbon monoxide, carbon dioxide, dinitrogen monoxide, nitrogen, methane, ethane, propane, 2,3-dimethylbutane, and ethylene. Among these, carbon dioxide is preferable, because it has a critical pressure of about 7.4 MPa and a critical temperature of about 31° C. and can be easily formed into a supercritical state, and it is non-flammable and easy to treat. One of these compressive fluids may be used alone, or two or more of these may be used in combination.

### <Multifunctional Initiator>

The multifunctional initiator is not particularly limited, and an arbitrary multifunctional initiator may be selected according to the purpose, as long as it is an initiator that imparts a branched structure to the polymer product. Examples of the multifunctional initiator include a polyhydric alcohol, and a polyvalent amine. Of these, a polyhydric alcohol is preferable.

It is preferable that the polymer product be obtained by ring-opening-polymerizing the ring-opening-polymerizable cyclic ester, using the polyhydric alcohol as an initiator.

### —Polyhydric Alcohol—

Examples of the polyhydric alcohol include a dihydric or higher alcohol, and a trihydric or higher alcohol. Of these, the trihydric or higher alcohol is preferable. Examples of the trihydric or higher alcohol include a trihydric or higher alcohol having 3 to 24 carbon atoms, and a castor oil-based polyol obtained by modifying a castor oil-derived raw material. Examples of the castor oil-based polyol include URIC H series manufactured by Itoh Oil Chemicals Co., Ltd.

A polymer having a plurality of hydroxyl groups may also be used as the multifunctional initiator. Examples of such polymers include a polyvinyl alcohol, and a polyacrylic acid derivative having hydroxyl groups, such as 2-hydroxyethyl polymethacrylate.

A graft copolymer is a polymer having other polymers at some points of the trunk copolymer like branches. When the polymer having a plurality of hydroxyl groups presented as the multifunctional initiator is assumed to be a trunk, a copolymer can be said to be a graft copolymer.

Also the trunk polymer can be expected to be plasticized depending on the compressive fluid selected. As the combinations, dimethyl ether having an ether bond is preferable for polyvinyl alcohol, and carbon dioxide is preferable for 2-hydroxyethyl polymethacrylate. It is also possible to copolymerize a copolymerization component in consideration of compatibility thereof with the compressive fluid.

Examples of the trihydric or higher alcohol having 3 to 24 carbon atoms include 1,2,4-butanetriol, 1,2,5-pentanetirol, 1, 2,6-hexanetirol, 1,2,3,6-hexanetetrol, glycerin, diglycerin, triglycerin, tetraglycerin, pentaglycerin, hexaglycerin, triethanolamine, trimethylolethane, trimethylolpropane, ditrimethylolpropane, tritrimethylolpropane, 2-methylpropanetriol, 2-methyl-1,2,4-butanetriol, pentaerythritol, dipentaerythritol, tripentaerythritol, methylglucoside, sorbitol, mannitol, sucrose, 1,3,5-trihydroxybenzene, and 1, 2,4-trihydroxybenzene.

Among these, a castor oil-based polyol, glycerin, diglycerin, trimethylolpropane, ditrimethylolpropane, pentaerythritol, and dipentaerythritol are preferable in terms of mechanical properties of the polymer product to be obtained. However, the trihydric or higher alcohol having 3 to 24 carbon atoms is not limited to these.

One of these may be used alone, or two or more of these may be used in combination.

### <Other Components>

Other components that may be used in the production of the polymer product are not particularly limited, and arbitrary components may be selected according to the purpose. Examples thereof include a catalyst and additives.

### —Catalyst—

The catalyst is not particularly limited, and an arbitrary catalyst may be selected according to the purpose. Examples thereof include an organic catalyst and a metal catalyst.

### —Organic Catalyst—

The organic catalyst is not particularly limited, and an arbitrary organic catalyst may be selected according to the purpose. A preferable example thereof is a catalyst that is free from a metal atom, contributes to a ring opening polymerization reaction of the ring-opening-polymerizable monomer, and after forming an active intermediate with the ring-opening-polymerizable monomer, is removed and recycled through a reaction with an alcohol.

For example, for polymerization of a ring-opening-polymerizable monomer having an ester bond, the organic catalyst is preferably a (nucleophilic) compound functioning as a nucleophile having basicity, more preferably a compound containing a nitrogen atom, and particularly preferably a cyclic compound containing a nitrogen atom. Such a compound is not particularly limited, and arbitrary compound may be selected according to the purpose. Examples thereof include a cyclic monoamine, a cyclic diamine (e.g., a cyclic diamine compound having an amidine skeleton), acyclic triamine compound having a guanidine skeleton, a heterocyclic aromatic organic compound containing a nitrogen atom, and N-heterocyclic carbene. Note that a cationic organic catalyst tends to be used for ring opening polymerization. However, in this case, hydrogen may be withdrawn from the polymer main chain (back-biting), which may result in a broad molecular weight distribution and make it harder to obtain a high molecular weight product.

Examples of the cyclic monoamine include quinuclidine.

Examples of the cyclic diamine include
1,4-diazabicyclo-[2.2.2]octane (DABCO), and
1,5-diazabicyclo(4,3,0)-5-nonene.

Examples of the cyclic diamine compound having an amidine skeleton include 1,8-diazabicyclo[5.4.0]undec-7-ene (DBU), and diazabicyclononene.

Examples of the cyclic triamine compound having a guanidine skeleton include 1,5,7-triazabicyclo[4.4.0]dec-5-ene (TBD), and diphenyl guanidine (DPG).

Examples of the heterocyclic aromatic organic compound containing a nitrogen atom include N,N-dimethyl-4-aminopyridine (DMAP), 4-pyrrolidinopyridine (PPY), pyrrocoline, imidazole, pyrimidine, and purine.

Examples of the N-heterocyclic carbene include 1,3-di-tert-butylimidazole-2-ylidene (ITBU).

Among these, DABCO, DBU, DPG, TBD, DMAP, PPY, and ITBU are preferable because they have low steric effects and a high nucleophilicity, or because they have a boiling point that enables the organic catalyst to be removed at reduced pressure.

Among these organic catalysts, for example, DBU is liquid at room temperature and has a boiling point. When such an organic catalyst is selected, it is possible to remove the organic catalyst substantially quantitatively from the polymer product obtained, by decompressing the polymer product. Note that the kind of the organic catalyst and whether or not to perform decompression are determined depending on the purpose for which the product is used, etc.

### —Metal Catalyst—

The metal catalyst is not particularly limited, and an arbitrary metal catalyst may be selected according to the purpose. Examples thereof include a tin-based compound, an aluminum-based compound, a titanium-based compound, a zirconium-based compound, and an antimony-based compound.

Examples of the tin-based compound include tin octylate, tin dibutylate, and tin di(2-ethylhexanoate).

Examples of the aluminum-based compound include aluminum acetyl acetonate, and aluminum acetate.

Examples of the titanium-based compound include tetraisopropyl titanate, and tetrabutyl titanate.

Examples of the zirconium-based compound include zirconium isopropoxide.

Examples of the antimony-based compound include antimony trioxide.

The kind and the amount of use of the catalyst vary depending on the combination of the compressive fluid and the ring-opening-polymerizable monomer, and cannot be specified flatly. However, in the case of an organic catalyst, the amount of use thereof is preferably from 0.01 mol % to 15 mol %, more preferably from 0.1 mol % to 1 mol %, and particularly preferably from 0.3 mol % to 0.5 mol %, relative to 100 mol % of the ring-opening-polymerizable monomer. When the amount of use is less than 0.1 mol %, the catalyst may become inactive before the polymerization reaction ends, and a polymer product having the target molecular weight may not be obtained. When the amount of use is greater than 15 mol %, it may be hard to control the polymerization reaction. In the case of a metal catalyst, the amount of use thereof is preferably from 0.001 mol % to 0.1 mol %, and more preferably from 0.003 mol % to 0.01 mol %, relative to 100 mol % of the ring-opening-polymerizable monomer.

For an application in which the product must be safe and stable, the catalyst used in the polymerization step is preferably an organic catalyst (an organic catalyst free from a metal atom).

### —Additives—

In the polymerization step, additives may be added according to necessity. Examples of the additives include a surfactant and an antioxidant.

A preferable surfactant is a surfactant that melts in the compressive fluid, and has affinity to both of the compressive fluid and the ring-opening-polymerizable monomer. Expected effects of such a surfactant are that a polymerization reaction can advance uniformly, that a product having a narrow molecular weight distribution can be obtained, and that it is easier to obtain a polymer product having a particle state. When a surfactant is used, it may be added to the compressive fluid or may be added to the ring-opening-polymerizable monomer. For example, when carbon dioxide is used as the compressive fluid, a surfactant having a carbon dioxide affinity group and a monomer affinity group in the molecule thereof is used. Examples of such a surfactant include a fluorosurfactant, and a silicone-based surfactant.

The polymer product may contain an organic solvent or may be free from an organic solvent. The organic solvent is a solvent made of an organic substance that is liquid at normal temperature, does not chemically react with the solute, and is used as a reaction field. When the polymer product is a polylactic acid obtained through a ring-opening polymerization reaction, examples of the organic solvent include chloroform, methylene chloride, toluene, and tetrahydrofuran. When it is said that the polymer product is substantially free from an organic solvent, it is meant that the content rate of the organic solvent in the polymer product measured according to a measuring method described below is less than the detection limit (5 ppm), specifically. In terms of safety and stability, it is preferable not to use the organic solvent but to use the compressive fluid (e.g., supercritical carbon dioxide) alone as a solvent. However, it is also possible to use an organic solvent as an entrainer in combination with supercritical carbon dioxide.

### <Method for Measuring Residual Organic Solvent>

2-propanol (2 parts by mass) is added to the polymer product to be measured (1 part by mass), and they are dispersed ultrasonically for 30 minutes. After this, the resultant is stored in a refrigerator (5° C.) for 1 day or longer, and then the organic solvent is extracted from the polymer product. The supernatant liquid is analyzed according to gas chromatography (GC-14 A manufactured by Shimadzu Corporation), to quantitate the organic solvent and the residual monomer in the polymer product, to thereby measure the organic solvent concentration. The measurement conditions in the analysis are as follows.

Instrument: GC-14A manufactured by Shimadzu Corporation

Column: CBP20-M 50-0.25

Detector: FID

Amount of injection: from 1 μL to 5 μL

Carrier gas: He 2.5 kg/cm²

Hydrogen flow rate: 0.6 kg/cm²

Air flow rate: 0.5 kg/cm²

Chart speed: 5 mm/min

Sensitivity: Range101×Atten20

Column temperature: 40° C.

Injection Temp: 150° C.

### <Content Rate of Residual Monomer>

The content rate of the residual monomer in the polymer product is not particularly limited, and may be appropriately selected according to the purpose. However, it is preferably 5,000 ppm or lower, more preferably 2,000 ppm or lower, and particularly preferably 1,000 ppm or lower. The residual monomer contained in the polymer product includes the unreacted raw-material ring-opening-polymerizable monomer, and a ring-opening-polymerizable monomer produced through a depolymerization reaction. When the content rate of the residual monomer is greater than 5,000 ppm, the thermal property and durability of the polymer product may be unsatisfactory. The method for measuring the content rate of the residual monomer may be the method described in the Examples to be described later.

In the present invention, the method for producing the polymer product may be, when the polymer product is a star polymer, either of an arm-first method of synthesizing straight-chain segments to become branched chains first, and then grafting them to the core, and a co-first method of synthesizing a multifunctional initiator first as a component to become the core, and then synthesizing straight-chain segments to become branched chains.

When the polymer product is a dendrimer, the production method thereof may be either of a divergent method of repeating stepwise reactions from the core to increase the branches, and a convergent method of repeating stepwise reactions of the outer shell component and finally bond it to the core.

When the polymer product is a hyper branch polymer, a preferable production method thereof is a method of ring-opening-polymerizing a cyclic monomer in a chain reaction.

The polymer product has a high molecular weight. Therefore, in the production of the polymer product, it is possible to take out the polymer product smoothly by using an extrusion unit in the production apparatus for producing the polymer product.

The extrusion unit is a unit configured to extrude the polymerization product obtained by a polymerization unit to the outside. Examples thereof include a gear pump, a uniaxial extruder, and a multiaxial extruder.

### <Applications>

The polymer product of the present invention is excellent in flexibility and toughness as described above. Therefore, it can be molded into particles, a film, a sheet, a molded article, a fiber, etc., and used widely for applications such as daily necessities, industrial materials, agricultural materials, hygienic materials, medical products, cosmetics, electrophotographic toners, packaging materials, electric equipment materials, home appliances casings, automobile materials, etc.

### (Molded Product)

A molded product of the present invention is obtained by molding the polymer product of the present invention.

Examples of the molded product include particles, a film, a sheet, a molded article, and a fiber.

### <Particles>

Examples of a method for molding the polymer product into particles include a method of pulverizing the polymer product according to a conventionally publicly-known method. The particle diameter of the particles is not particularly limited, but is typically from 1 μm to 50 μm. When the particles as the molded product are an electrophotographic toner, a mixture is produced by mixing a colorant and hydrophobic particles in the polymer product. The mixture may contain, in addition to a binder resin, the colorant, and the hydrophobic particles, any other additive. Examples of the any other additive include a releasing agent and a charge controlling agent. The step of mixing the additive may be performed at the same time as the polymerization reaction, may be performed in a post process after the polymerization reaction, or may be performed after the polymerization product is taken out, while melt-kneading the polymerization product. There may be another kind of particles, which may be DDS (Drug Delivery System).

### <Film>

In the present embodiment, a film means a product that is obtained by molding the polymer product into a thin membrane, and has a thickness of less than 250 μm. In the present embodiment, a film is produced by stretch-molding the polymer product.

In this case, the method for stretch molding is not particularly limited. A uniaxial stretch molding method and a simultaneous or sequential biaxial stretch molding method (e.g., a tubular method, and a tenter method), which are used for stretch molding of general-purpose plastics, may be employed.

Film molding is performed typically in a temperature range of from 150° C. to 280° C. Uniaxial or biaxial stretching is applied to the molded film according to a roll method, a tenter method, a tubular method, or the like. The stretching temperature is typically from 30° C. to 110° C., and preferably from 50° C. to 100° C. The draw ratio is typically from 0.6 times to 10 times in both of the vertical and horizontal directions. After the stretching, a thermal treatment may be applied according to, for example, a method of blowing the product with hot air, a method of irradiating the product with infrared, a method of irradiating the product with a microwave, and a method of bringing the product into contact with a heat roll.

According to such a stretch molding method, various types of stretched films such as a stretched sheet, a flat yarn, a stretched tape or band, a streaked tape, and a split yarn can be obtained. The thickness of the stretched film is arbitrary depending on the application thereof, but typically 5 μm or greater, but less than 250 μm.

In order to impart surface functions such as a chemical function, an electric function, a magnetic function, a mechanistic function, a friction/wear/lubrication function, an optical function, a thermal function, and biocompatibility to the molded stretched film, it is possible to apply various types of secondary processing fit for the purposes to the stretched film. Examples of the secondary processing include embossing, painting, bonding, printing, metalizing (e.g., plating), mechanical machining, and surface treatments (e.g., an antistatic treatment, a corona discharge treatment, a plasma treatment, a photochromism treatment, physical vapor deposition, chemical vapor deposition, and coating).

The stretched film obtained in the present embodiment may contain or may be free from an organic solvent. However, it is preferable that the stretched film be free from an organic solvent because it will be excellent in safety. Hence, when the stretched film is free from an organic solvent, it may be used widely for medical purposes, food packaging purposes, daily necessities, electric equipment materials, home appliances casings, automobile materials, etc. because of its excellent safety. Particularly, the stretched film is useful for packaging substances that are susceptible to oxygen or may deteriorate, including foods. Further, when the stretched film contains a residual monomer in an amount of 5,000 ppm or less, the durability thereof can be enhanced, and coloring thereof can be suppressed.

### <Sheet/Molded Article>

In the present invention, the sheet is a product that is obtained by molding the polymer product into a thin membrane and has a thickness of 250 μm or greater. In the present embodiment, the sheet is produced by applying a conventionally publicly-known sheet production method used for a thermoplastic resin to the polymer product. Such a method is not particularly limited, and examples include a T-die method, an inflation method, and a calender method. Processing conditions for processing the polymer product into a sheet are determined appropriately based on the kind of the polymer product, equipment, etc. For example, to process a polylactic acid according to a T-die method, it is possible to produce a sheet thereof by extruding the polymer product heated to preferably from 150° C. to 250° C. from a T-die, using an extrusion molder having the T-die at the outlet.

In the present embodiment, the molded article is a product obtained by using a die. The concept of the molded article encompasses not only a single-piece molded article, but also a part composed of a molded article such as a handgrip of a tray, and a product having a molded article such as a tray to which a handgrip is attached.

The processing method is not particularly limited, and conventionally publicly-known plastic resin processing method may be employed. Examples thereof include injection molding, vacuum molding, pressure molding, vacuum pressure molding, and press molding. In this case, it is possible to obtain a molded article by melting and injection-molding the polymer product. It is also possible to impart a shape to the sheet obtained according to the production method described above, by press molding with a molding die. The processing conditions for imparting a shape are determined appropriately based on the kind of the polymer product, equipment, etc. For example, to impart a shape to a sheet made of a polylactic acid by press molding with a molding die, the temperature of the die may be set to from 100° C. to 150° C. To impart a shape by injection molding, the polymer product heated to from 150° C. to 250° C. may be injected into the die, and the temperature of the die may be set to from about 20° C. to 80° C.

Polylactic acids that have conventionally been used for general purposes contain a metal catalyst, an organic catalyst, and the monomer at high residual ratios. When such a polylactic acid is heated and shaped into a sheet, the residual heterogeneous matters such as the metal catalyst, the organic catalyst, and the monomer may appear as fish-eye artifacts and spoil the appearance of the sheet, or may degrade the strength. When such a polylactic acid is molded with a molding die or an injection die, the appearance of the obtained product may be spoiled, or the strength thereof may be degraded likewise.

As compared with this, the sheet and the molded article of the present embodiment may contain or may be free from an organic solvent. When they are free from an organic solvent, they are excellent in safety and favorable. Hence, the molded article free from an organic solvent can be used widely for purposes including but not particularly limited to a sheet, a packaging material, a tray, etc. for industrial materials, daily necessities, agricultural materials, foods, medical drugs, and cosmetics. Here, when the polymer product is a biodegradable polymer such as a polylactic acid and polycaprolactone, it is useful for applications involving possibilities of intake into the body, such as a packaging material used for, especially foods, and a sheet for cosmetics and medical drugs, with the solvent and metal-free property thereof taken advantage of. Further, when the residual monomer in the polymer product is 5,000 ppm or less, the durability thereof can be enhanced, and coloring thereof can be suppressed.

### <Fiber>

The polymer product can also be used for fibers such as a monofilament and a multifilament. In the present embodiment, the concept of the fiber encompasses not only a simple fiber such as a monofilament, but also an intermediate product made from a fiber such as woven fabric and non-woven fabric, and a product including woven fabric or non-woven fabric.

In the present embodiment, the fiber, when it is a monofilament, is produced by shaping the polymer product into a fiber by melt spinning, cooling, and stretching the polymer product according to a conventionally publicly-known method. Depending on the purpose, the monofilament may be coated with a coating layer according to a conventionally publicly-known method. The coating layer may contain an antimicrobial agent, a colorant, etc. When the fiber is non-woven fabric, the production method thereof may be a method of performing melt spinning, cooling, stretching, opening, depositing, and a thermal treatment according to a conventionally publicly-known method. The polymer product may contain additives such as an antioxidant, a flame retardant, an ultraviolet absorbing agent, an antistatic agent, an antimicrobial agent, and a binder resin. The step of mixing the additives may be performed at the same time as the polymerization reaction, may be performed in a post process after the polymerization reaction, or may be performed after the polymerization product is taken out, while melt-kneading the polymerization product.

The fiber obtained in the present embodiment may contain or may be free from an organic solvent. When it is free from an organic solvent, it is excellent in safety and favorable. Hence, the fiber free from an organic solvent, when it is a monofilament, can be used widely for applications such as a fishing line, a fishnet, a suture thread for medical operations, electric equipment materials, automobile materials, and industrial materials. When it is non-woven fabric, the fiber of the present embodiment can be used widely for applications such as fishery/agricultural materials, building/civil engineering materials, interiors, automobile materials, packaging materials, daily goods, and hygienic materials. Further, when the residual monomer in the polymer product is 5,000 ppm or less, the durability thereof can be enhanced, and coloring thereof can be suppressed.

### [Polymerization Reaction Equipment]

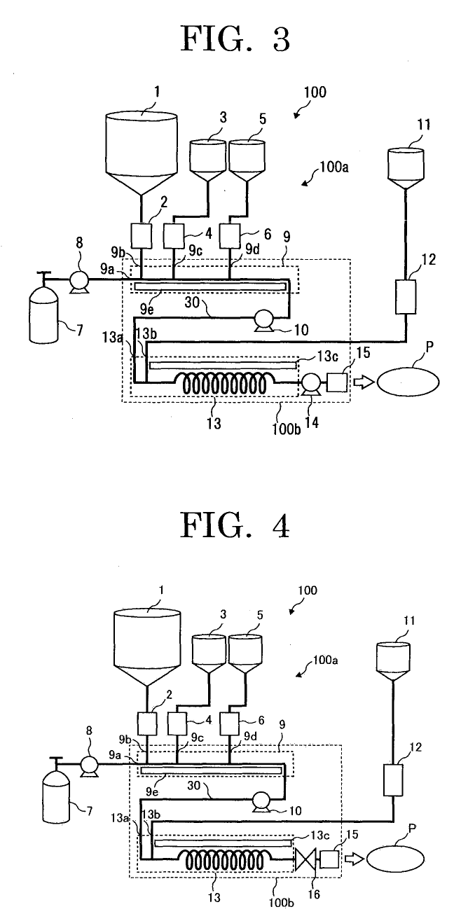

Next, an example of a polymerization reaction equipment used for production of the polymer product will be explained with reference to FIG. 3 and FIG. 4. FIG. 3 and FIG. 4 are system diagrams showing examples of polymerization steps. First, a polymerization reaction equipment 100 will be explained with reference to FIG. 3. The polymerization reaction equipment 100 includes a feeding unit 100a configured to feed a raw material such as a ring-opening-polymerizable monomer, and a compressive fluid, and a polymerization reaction equipment body 100b that is one example of a polymer production equipment configured to polymerize the ring-opening-polymerizable monomer fed by the feeding unit 100a. The feeding unit 100a includes tanks (1, 3, 5, 7, and 11), gauge feeders (2, and 4), and gauge pumps (6, 8, and 12). The polymerization reaction equipment body 100b includes a contact region 9 provided at one end of the polymerization reaction equipment body 100b, a liquid delivering pump 10, a reaction, a gauge pump 14, and an extrusion nozzle 15 provided at the other end of the polymerization reaction equipment body 100b.

The tank 1 of the feeding unit 100a stores a ring-opening-polymerizable monomer. The ring-opening-polymerizable monomer stored may be a powder or a liquid. The tank 3 stores any of an initiator, a catalyst, and additives that is/are solid (powdery or particulate). The tank 5 stores any of the initiator, the catalyst, and the additives that is/are liquid. Another tank may be provided side by side with the tank 5, and may store the initiator, or the catalyst and the additives in a solid or liquid state. The tank 7 stores a compressive fluid. The tank 7 may store a gas or a solid that turns to a compressive fluid by being heated or pressurized, through a process of being fed into the contact region 9, or in the contact region 9. In this case, the gas or the solid stored in the tank 7 comes to have the state of (1), (2), or (3) in the phase diagram of FIG. 2 in the contact region 9, by being heated or pressurized.

The gauge feeder 2 is configured to gauge the ring-opening-polymerizable monomer stored in the tank 1 and feed it into the contact region 9 continuously. The gauge feeder 4 is configured to gauge the solid stored in the tank 3 and feed it into the contact region 9 continuously. The gauge pump 6 is configured to gauge the liquid stored in the tank 5 and feed it into the contact region 9 continuously. The gauge pump 8 is configured to feed the compressive fluid stored in the tank 7 into the contact region 9 continuously at a constant pressure and a constant flow rate. In the present embodiment, continuous feeding is a concept opposed to batch-wise feeding, and means to feed the materials in a fashion to make it possible to continuously obtain the polymer product that is produced by ring-opening-polymerizing the ring-opening-polymerizable monomer. That is to say, as long as the polymer product produced by ring-opening-polymerizing the ring-opening-polymerizable monomer can be obtained continuously, the materials may be fed off and on, or intermittently. When all of the initiator and the additives are solid, the polymerization reaction equipment 100 needs not include the tank 5 and the gauge pump 6. Likewise, when all of the initiator and the additives are liquid, the polymerization reaction equipment 100 needs not include the tank 3 and the gauge feeder 4.

In the present embodiment, the polymerization reaction equipment body 100b is a tubular equipment that is provided at one end thereof with a monomer inlet through which the ring-opening-polymerizable monomer is introduced, and at the other end thereof with a discharge outlet through which the polymer product produced by polymerizing the ring-opening-polymerizable monomer is discharged. The polymerization reaction equipment body 100b is also provided at the one end thereof with a compressive fluid inlet through which the compressive fluid is introduced, and at a portion between the one end and the other end thereof with a catalyst inlet through which the catalyst is introduced. The respective devices of the polymerization reaction equipment body 100b are connected to one another by means of a pressure-tight tube 30 through which the raw materials, the compressive fluid, or the produced polymer product are/is conveyed, as shown in FIG. 3. Each of the contact region 9, the liquid delivering pump 10, and the reaction region 13 of the polymerization reaction equipment include a tubular member through which the raw materials, etc. described above are passed.

The contact region 9 of the polymerization reaction equipment body 100b is constituted by a pressure-tight device or tube in which the raw materials such as the ring-opening-polymerizable monomer, the initiator, the additives, etc. fed from the tanks (1, 3, and 5), and the compressive fluid fed from the tank 7 are brought into contact with each other continuously for the raw materials to be mixed (for example, for the ring-opening-polymerizable monomer and the initiator to be melted or dissolved). In the present embodiment, “melted” means a state of the raw materials or the produced polymer product having plasticized or liquefied while having swollen by contacting the compressive fluid. “Dissolved” means a state of the raw materials having deliquesced in the compressive fluid. A fluid phase is formed when the ring-opening-polymerizable monomer is dissolved, and a melt phase is formed when it is melted. In order for the reaction to advance uniformly, it is preferable that one of the melt phase and the fluid phase be formed. In order for the reaction to advance in a state that the ratios of the raw materials are higher than the ratio of the compressive fluid, it is preferable that the ring-opening-polymerizable monomer be melted. In the present embodiment, it is possible to bring the raw materials such as the ring-opening-polymerizable monomer and the compressive fluid into contact with each other in the contact region 9 continuously at a constant concentration ratio, by feeding the raw materials and the compressive fluid continuously. This makes is possible to mix the raw materials efficiently (for example, to melt or dissolve the ring-opening-polymerizable monomer and a branched monomer).

The contact region 9 may be constituted by a tank-shaped device or by a tubular device. However, it is preferably a tubular device into which the raw materials are fed through one end thereof, and from which a mixture such as a melt phase or a fluid phase is discharged through the other end thereof. The contact region 9 may further include a stirrer configured to stir the raw materials, the compressive fluid, etc. When the contact region 9 includes a stirrer, the stirrer is preferably a uniaxial screw, biaxial screws meshing with each other, a biaxial mixer including multiple stirring elements meshing or overlapping with one another, a kneader including spiral stirring elements meshing with each other, and a static mixer. Particularly, a biaxial or multiaxial stirrer including meshing elements is preferable, because it can suppress deposition of a reaction product onto the stirrer or a vessel, and has a self-cleaning function. When the contact region 9 includes no stirrer, it is preferable that the contact region 9 be constituted by part of the pressure-tight tube 30. When the contact region 9 is constituted by the tube 30, it is preferable that the ring-opening-polymerizable monomer to be fed into the contact region 9 be liquefied beforehand, in order for the materials to be mixed in the contact region 9 unfailingly.

The contact region 9 has an inlet port 9a as an example of a compressive fluid inlet through which the compressive fluid fed from the tank 7 by the gauge pump 8 is introduced, an inlet 9b as an example of a monomer inlet through which the ring-opening-polymerizable monomer fed from the tank 1 by the gauge feeder 2 is introduced, an inlet 9c through which a powder fed from the tank 3 by the gauge feeder 4 is introduced, and an inlet 9d through which a liquid fed from the tank 5 by the gauge pump 6 is introduced. In the present embodiment, the inlets (9a, 9b, 9c, and 9d) are constituted by joints configured to couple the tubular member such as a cylinder or part of the tube 30 for the raw materials, etc to be fed in the contact region 9, to the respective tubes through which the raw materials or the compressive fluid are conveyed. The joints are not particularly limited, and may be publicly-known joints such as a reducer, a coupling, a Y, a T, and an outlet. The contact region 9 is also provided with a heater 9e configured to heat the raw materials and the compressive fluid fed.

The liquid delivering pump 10 delivers a mixture such as a melt phase or a fluid phase formed in the contact region 9 into the reaction region 13. The tank 11 stores a catalyst. The gauge pump 12 gauges the catalyst stored in the tank 11 and feeds it into the reaction region 13. The reaction region 13 is constituted by a pressure-tight device or tube in which the raw materials delivered by the liquid delivering pump 10 and the catalyst fed by the gauge pump 12 are mixed with each other in order for the ring-opening-polymerizable monomer to be ring-opening-polymerized. The reaction region 13 may be constituted by a tank-shaped device or by a tubular device. However, it is preferably a tubular device because a tubular device includes less dead space. The reaction region 13 may also include a stirrer configured to stir the raw materials, the compressive fluid, etc. The stirrer of the reaction region 13 is preferably screws meshing with each other, a 2-flight (oval) or 3-flight (triangular) stirring element, and a biaxial or multiaxial stirrer including a discus or multifoil (e.g., a clover-shaped) stirring blade, in terms of self-cleaning functionality. When the raw materials including the catalyst are mixed sufficiently beforehand, the stirrer may be a static mixer configured to perform splitting and merging (converging) of a flow over multi-stages with a guide device. Examples of static mixers include those disclosed in Japanese Patent Application Publication (JP-B) Nos. 47-15526, 47-15527, 47-15528, and 47-15533 (multi-layering mixers), one disclosed in JP-A No. 47-33166 (Kenics type), and mixers similar to those above that include no movable part. When the reaction region 13 includes no stirrer, the reaction region 13 is constituted by part of the pressure-tight tube 30. In this case, the shape of the tube is not particularly limited. However, it is preferably a spiral shape in order to suppress the size of the equipment.

The reaction region 13 has an inlet 13a through which the raw materials mixed in the contact region 9 are introduced, and an inlet 13b as an example of a catalyst inlet through which the catalyst fed from the tank 11 by the gauge pump 12 is introduced. In the present embodiment, the inlets (13a and 13b) are constituted by joints configured to couple the tubular member such as a cylinder or part of the tube 30 through which the raw materials, etc. are passed in the contact region 13, to the respective tubes through which the raw materials or the compressive fluid are fed. The joints are not particularly limited, and may be publicly-known joints such as a reducer, a coupling, a Y, a T, and an outlet. The reaction region 13 may have a gas outlet through which an evaporant is removed. The reaction region 13 is also provided with a heater 13c configured to heat the delivered raw materials.

FIG. 3 shows an example in which there is one reaction region 13. The polymerization reaction equipment 100 may include two or more reaction regions 13. When it includes two or more reaction regions 13, the reaction (polymerization) conditions such as temperature, catalyst concentration, pressure, average retention time, and stirring speed may be unified in all of the reaction regions 13. However, it is preferable that optimum conditions be selected for each one. It is not advisable to couple too many reaction regions 13 over multi-stages, because this would increase the reaction time or complicate the equipment. The number of stages is preferable from 1 to 4, and particularly preferably from 1 to 3.

Generally, when polymerization is performed with only one reaction region, the degree of polymerization and the residual monomer content of the polymer product to be produced from polymerization of the ring-opening-polymerizable monomer tend to be unstable and vary from product to product, and such a polymerization process is unsuitable as industrial production. This instability is considered to be attributed to instability due to mixed presence of the raw materials having a melt viscosity of from several poise to several ten poise and the polymerized polymer product having a melt viscosity of several thousand poise. In this regard, in the present embodiment, the raw materials and the produced polymer product can have a small viscosity difference in the reaction region 13 (also referred to as polymerization system) by melting (liquefying). This makes it possible to produce the polymer product stably, even though the number of stages is smaller than that in a conventional polymerization reaction equipment.

The gauge pump 14 sends the polymer product P polymerized in the reaction region 13 to the outside of the reaction region 13 through the extrusion nozzle 15. Note that with a pressure difference between the inside and the outside of the reaction region 13 utilized, the polymer product P may be sent out from the reaction region 13 without the gauge pump 14. In this case, in order for the pressure in the reaction region 13 and the amount of the polymer product P to be sent out to be adjusted, a pressure adjusting valve 16 may be used as shown in FIG. 4 instead of the gauge pump 14.

The polymerization reaction equipment body 100b may include other units. The other units are not particularly limited, and arbitrary units may be selected according to the purpose. Examples thereof include a cooling unit used for a process for cooling the polymer product (a cooling step), a drying unit used for a process for drying the polymer product (a drying step), and an extruding unit used for an extrusion process (an extrusion step).

The extrusion unit is a unit configured to extrude the polymer product P obtained in the polymerization reaction equipment body 100b to the outside. Examples thereof include a gear pump, a uniaxial extruder, and a multiaxial extruder. With the extrusion unit, the polymer product can be taken out from the polymerization reaction equipment body 100b.

In the polymerization reaction, an organic solvent may be used as an entrainer, which may make it possible to save the reaction time.

### First Embodiment

Next, a continuous production method of a polymer product using the polymerization reaction equipment 100 (first embodiment) will be explained. In the present embodiment, a ring-opening-polymerizable monomer, a compressive fluid, and according to necessity, other components are fed and brought into contact with one another continuously, and the ring-opening-polymerizable monomer is ring-opening-polymerized continuously, to thereby obtain a polymer product continuously. In this case, the gauge feeders (2 and 4), the gauge pump 6, and the gauge pump 8 are actuated, and the ring-opening-polymerizable monomer, the initiator, the additives, and the compressive fluid in the tanks (1, 3, 5, and 7) are fed into the contact region 9 continuously. In feeding the catalyst into the contact region 9, it is possible to feed it together with the ring-opening-polymerizable monomer, the initiator, the additives, and the compressive fluid, or to feed it in an order from an additional tank. The catalyst may be added in the reaction region 13 (late addition), instead of being added in the contact region 9 (early addition). In this case, an effect that the polymer conversion rate is improved can be obtained because the monomer and the catalyst can contact each other over a large area, as the catalyst is added to a uniform phase in which the monomer has melted completely.

Next, a method for increasing the density of the compressive fluid in the polymerization equipment during the reaction will be explained. First, the gauge pump 8 is actuated to feed into the contact region 9 and adjust the pressure in the contact region to a predetermined pressure. Next, the liquid delivering pump 10 is actuated to raise the pressure in the reaction region 13 to a pressure higher than that in the contact region 9. Through this operation for raising the pressure, the density of the compressive fluid can be changed in the continuous equipment shown in FIG. 3 during the reaction. It is preferable to change the density of the compressive fluid by means of pressure as described above. However, it is also possible to increase the density of the compressive fluid by lowering the temperature in the reaction region 13. By using this method to thereby increase the density of the compressive fluid (e.g., supercritical carbon dioxide), it is possible to suppress the viscosity of the polymer during the polymerization, regardless of whether an organic solvent is used or not.

The raw materials and the compressive fluid are introduced into the tube of the contact region 9 continuously through the inlets (9a, 9b, 9c, and 9d). Solid (powdery or particulate) raw materials may tend to be gauged less precisely than liquid raw materials. In this case, solid raw materials may be melted beforehand, stored in the tank 5 in a liquid state, and introduced into the tube of the contact region 9 by the gauge pump 6. The order to actuate the gauge feeders (2 and 4), the gauge pump 6, and the gauge pump 8 is not particularly limited. However, if the initial raw materials are sent into the reaction region 13 without contacting the compressive fluid, they may be solidified when the temperature lowers. Therefore, it is preferable to actuate the gauge pump 8 first.

The feeding rates at which the gauge feeders (2 and 4) and the gauge pump 6 feed the raw materials are adjusted to a constant ratio based on a predetermined ratio between the amounts of the ring-opening-polymerizable monomer, the initiator, the catalyst, and the additives. The total mass of the raw materials fed by the gauge feeders (2 and 4) and the gauge pump 6 per unit time (a raw material feeding rate (g/min)) is adjusted based on a desired polymer property, a reaction time, etc. Likewise, the mass of the compressive fluid fed by the gauge pump 8 per unit time (a compressive fluid feeding rate (g/min)) is adjusted based on a desired polymer property, a reaction time, etc. The ratio between the compressive fluid feeding rate and the raw material feeding rate (raw material feeding rate/compressive fluid feeding rate, referred to as feeding ratio) is not particularly limited, and may be appropriately selected according to the purpose. However, it is preferably 1 or greater, more preferably 3 or greater, yet more preferably 5 or greater, and particularly preferably 10 or greater. The upper limit of the feeding ratio is not particularly limited, and may be appropriately selected according to the purpose. However, it is preferably 1,000 or less, more preferably 100 or less, and particularly preferably 50 or less.

With the feeding ratio set to 1 or greater, when the raw materials and the compressive fluid are sent into the reaction region 13, the reaction advances in a state that the concentration of the raw materials and the produced polymer product (i.e., a so-called solid content concentration) is high. This solid content concentration in the polymerization system is greatly different from a solid content concentration in a polymerization system in which a small amount of a ring-opening-polymerizable monomer is dissolved and polymerized in an overwhelming amount of a compressive fluid according to a conventional production method. A characteristic of the production method of the present embodiment is that a polymerization reaction advances efficiently and stably even in a polymerization system in which the solid content concentration is high. In the present embodiment, the feeding ratio may be less than 1. Even in this case, the quality of the polymer product to be obtained is non-problematic, but the cost-efficiency thereof may be poor. When the feeding ratio is greater than 1,000, the capacity of the compressive fluid to dissolve the ring-opening-polymerizable monomer may be insufficient, and the intended reaction may not advance uniformly.

The raw materials and the compressive fluid are introduced into the tube of the contact region 9 continuously. Therefore, they contact with one another continuously. As a result, the raw materials such as the ring-opening-polymerizable monomer, the initiator, and the additive are mixed in the contact region 9. When the contact region 9 includes a stirrer, the raw materials and the compressive fluid may be stirred. In order for the introduced compressive fluid to avoid turning to a gas, the temperature and pressure in the tube of the reaction region 13 are controlled to a temperature and pressure equal to or higher than at least the triple point of the compressive fluid. In this case, it is preferable that the ring-opening-polymerizable monomer and the compressive fluid be brought into contact with each other at a pressure of 3 MPa or higher, and it is more preferable that they be brought into contact with each other at 7.4 MPa or higher. This pressure is controlled based on the flow rate of the pump, the diameter of the tube, the length of the tube, the shape of the tube, etc. This controlling is performed by adjusting the output of the heater 9e in the contact region 9 or the compressive fluid feeding rate. In the present embodiment, the temperature set when melting the ring-opening-polymerizable monomer may be a temperature equal to or lower than the melting point of the ring-opening-polymerizable monomer at normal pressure. This is considered to be because the contact region 9 becomes a high pressure in the presence of the compressive fluid, and the melting point of the ring-opening-polymerizable monomer becomes lower than the melting point thereof at normal pressure. Hence, even when the amount of the compressive fluid relative to the ring-opening-polymerizable monomer is low, the ring-opening-polymerizable monomer can melt in the contact region 9.

In order for the raw materials to be mixed efficiently, the timing to apply heat and stirring to the raw materials and the compressive fluid in the contact region 9 may be adjusted. In this case, heat and stirring may be applied after the raw materials and the compressive fluid are brought into contact with each other, or heat and stirring may be applied while the raw materials and the compressive fluid are brought into contact with each other. In order for them to be mixed more unfailingly, for example, the ring-opening-polymerizable monomer and the compressive fluid may be brought into contact with each other after heat equal to or higher than the melting point of the ring-opening-polymerizable monomer is applied to the ring-opening-polymerizable monomer beforehand. Each of these modes is realized by appropriately setting the arrangement of the screws when the contact region is, for example, a biaxial mixer, the arrangement of the inlets (9a, 9b, 9c, and 9d), or the temperature of the heater 9e. In the present embodiment, the additives are fed into the contact region 9 separately from the ring-opening-polymerizable monomer. However, the additives may be fed together with the ring-opening-polymerizable monomer. Alternatively, the additives may be fed after the polymerization reaction. In this case, the additives may be added while the obtained polymer product is kneaded, after the polymer product is taken out from the reaction region 13.

The raw materials mixed in the contact region 9 are delivered by the liquid delivering pump 10 and fed into the reaction region 13 through the inlet 13a. On the other hand, in the case of late addition of the catalyst, the catalyst in the tank 11 is gauged by the gauge pump 12, and fed in a predetermined amount into the reaction region 13 through the inlet 13b.

The raw materials and the catalyst are heated by the heater 13c to a predetermined temperature (a polymerization reaction temperature), while they are mixed sufficiently by the stirrer in the reaction region 13 according to necessity, or while they are delivered. As a result, the ring-opening-polymerizable monomer is ring-opening-polymerized in the reaction region 13 in the presence of the catalyst (a polymerization step). The polymerization reaction temperature is not particularly limited, and may be appropriately selected according to the purpose. However, it is preferably 200° C. or lower, and more preferably from 40° C. to 180° C. When the polymerization reaction temperature is higher than 200° C., it becomes easier for a depolymerization reaction, which is a reverse reaction of ring-opening polymerization, to occur in parallel, which may make it harder for the polymerization reaction to advance quantitatively, and may make it likely for the polymer product to be colored. On the other hand, when the polymerization reaction temperature is lower than 40° C., the ring-opening-polymerizable monomer may take a long time to be dissolved in the compressive fluid or may be melted insufficiently depending on the kind of the ring-opening-polymerizable monomer, or the activity of the catalyst may be low. This may make the reaction speed of the polymerization low, or make it impossible for the polymerization reaction to advance quantitatively. The polymerization reaction temperature is controlled by, for example, a heater provided in the polymerization reaction equipment, or heating from the outside.

In a conventional polymer product production method using supercritical carbon dioxide, a ring-opening-polymerizable monomer has been polymerized with a large amount of supercritical carbon dioxide, because supercritical carbon dioxide has a low dissolving power of dissolving a polymer product. According to the polymerization method of the present embodiment, the ring-opening-polymerizable monomer can be ring-opening-polymerized at an unprecedentedly high concentration that has not been achieved by any conventional polymer product production method using a compressive fluid. In this case, the reaction region 13 becomes a high pressure in the presence of the compressive fluid, and a polymer product is produced to have a low glass transition temperature (T_{g}), and as a result, a low viscosity. Therefore, the ring-opening polymerization reaction can advance uniformly even when the concentration of the polymer product becomes high.

In the present embodiment, the polymerization reaction time (an average retention time in the reaction region 13) is set according to the intended molecular weight. However, typically, it is preferably 1 hour or shorter, more preferably 45 minutes or shorter, and particularly preferably 30 minutes or shorter. According to the production method of the present embodiment, the polymerization reaction time may be 20 minutes or shorter. This is an unprecedentedly short time for polymerization of a ring-opening-polymerizable monomer in a compressive fluid.

The amount of moisture in the reaction region 13 is preferably 4 mol % or lower, more preferably 1 mol % or lower, and particularly preferably 0.5 mol % or lower, relative to 100 mol % of the ring-opening-polymerizable monomer. When the amount of moisture is greater than 4 mol %, the moisture itself contributes as an initiator, which may make it difficult to control the molecular weight. In order to control the amount of moisture in the polymerization system, it is possible to add an operation for removing moisture contained in the ring-opening-polymerizable monomer and the other raw materials, as a pre-treatment, according to necessity.

The polymer product P that has completed the ring-opening-polymerization reaction in the reaction region 13 is sent out of the reaction region 13 by the gauge pump 14. It is preferable that the rate at which the gauge pump 14 sends out the polymer product P be constant, in order for the polymerization system filled with the compressive fluid to be driven at a constant pressure, and for a uniform polymer product to be obtained. For this purpose, the liquid delivering mechanism in the reaction region 13 and the liquid delivering amount of the liquid delivering pump 10 are controlled such that the back pressure of the gauge pump 14 may be constant. Likewise, the liquid delivering mechanism in the contact region 9 and the feeding rates of the gauge feeders (2 and 4) and gauge pumps (6 and 8) are controlled such that the back pressure of the liquid delivering pump 10 may be constant. The control method may be an ON-OFF system, i.e., an intermittent feeding system. However, a continuous or step system of gradually increasing or decreasing the rotational speed of the pumps, etc. is often more preferable. In any way, such a control makes it possible to obtain a uniform polymer product stably.

The residual catalyst in the polymer product obtained in the present embodiment is removed according to necessity. The removal method is not particularly limited, and examples thereof include distillation at reduced pressure, and extraction using a compressive fluid. In the case of distillation at reduced pressure, the pressure reducing conditions are set based on the boiling point of the catalyst. For example, the temperature when the pressure is reduced is from 100° C. to 120° C., and the catalyst can be removed at a temperature lower than the temperature at which the polymer product is depolymerized. Hence, it is preferable to use a compressive fluid as a solvent also in the extraction operation. A publicly-known technique for aroma chemical extraction may be employed as such an extraction operation.

### Second Embodiment

Next, a second embodiment will be explained, in terms of differences from the first embodiment. In the production method of the first embodiment, a reaction advances quantitatively with substantially no residual monomer. With this characteristic utilized, a first method of the second embodiment synthesizes a complex polymer product by performing polymerization using the polymer product produced according to the production method of the first embodiment, and one or more further kinds of ring-opening-polymerizable monomer(s) in addition. A second method of the second embodiment forms a complex by mixing two or more kinds of polymers including the polymer product produced according to the production method of the first embodiment, continuously in the presence of a compressive fluid. In the present embodiment, a “complex” means a copolymer including two or more kinds of polymer segments obtained by polymerizing monomers through a plurality of separate systems, or a mixture of two or more kinds of polymer products obtained by polymerizing monomers through a plurality of separate systems.

Caprolactone, as an example of a complex, and a copolymer production method will be described below.

### [[First Method and Equipment]]

According to the first method, a first ring-opening-polymerizable monomer is polymerized through a polymerization step (a first polymerization step) similar to the first embodiment, to thereby obtain a first polymer product. The obtained first polymer product and a second ring-opening-polymerizable monomer are brought into contact with each other continuously, to thereby polymerize the first polymer product with the second ring-opening-polymerizable monomer (a second polymerization step). The first method may include any other step according to necessity.

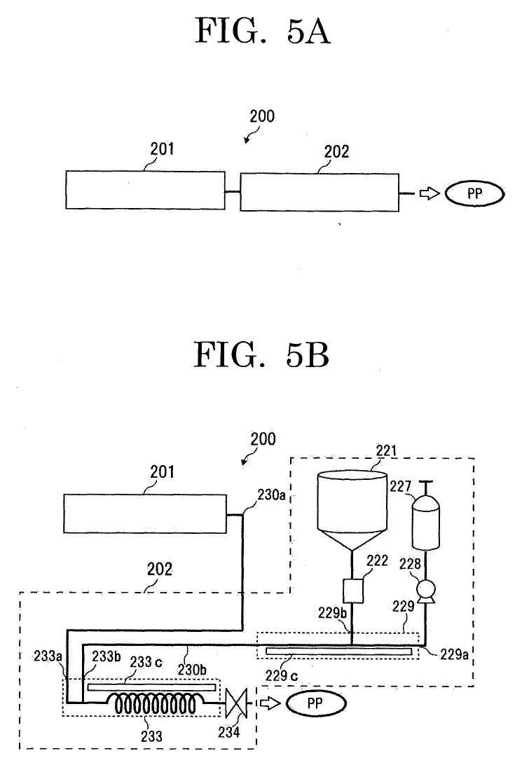

Production of the polymer product according to the first method can be realized with the complex production equipment 200 shown in FIG. 5A and FIG. 5B. FIG. 5A and FIG. 5B are exemplary diagrams showing a complex production equipment. As shown in FIG. 5A, the complex production equipment 200 includes a first polymerization reaction equipment 201 having the same configuration as that of the polymerization reaction equipment 100, and a second polymerization reaction equipment 202. The detailed configuration of the second polymerization reaction equipment is shown in FIG. 5B. The second polymerization reaction equipment 202 includes tanks (221 and 227), a gauge feeder 222, a gauge pump 228, a contact region 229, a reaction region 233, and a pressure adjusting valve 234.

The tank 221 stores a second ring-opening-polymerizable monomer. In the first method, the second ring-opening-polymerizable monomer is a ring-opening-polymerizable monomer different from the first ring-opening-polymerizable monomer. The ring-opening-polymerizable monomer may be selected from those raised as examples of the ring-opening-polymerizable monomer described above. Examples thereof include glycolide, caprolactone, and mevalonolactone. The tank 227 includes a compressive fluid. The compressive fluid stored in the tank 227 is not particularly limited, but is preferably the same as the compressive fluid used in the first polymerization reaction equipment 201 in order for a polymerization reaction to advance uniformly. The tank 227 may store a gas or a solid that turns to a compressive fluid by being heated or pressurized, through a process of being fed into a contact region 229, or in the contact region 229. In this case, the gas or the solid stored in the tank 227 comes to have the state of (1), (2), or (3) in the phase diagram of FIG. 2 in the contact region 229, by being heated or pressurized.

The gauge feeder 222 gauges the second ring-opening-polymerizable monomer stored in the tank 21 and feeds it into the contact region 229 continuously. The gauge pump 228 feeds the compressive fluid stored in the tank 227 into the contact region 229 continuously at a constant pressure at a constant flow rate.

The contact region 229 is constituted by a pressure-tight device or tube in which the second ring-opening-polymerizable monomer fed from the tank 221 and the compressive fluid fed from the tank 227 are brought into contact with each other continuously in order for the raw material to be dissolved or melted. The vessel constituting the contact region 229 has an inlet 229a through which the compressive fluid fed from the tank 227 by the gauge pump 228 is introduced, and an inlet 229b through which the second ring-opening-polymerizable monomer fed from the tank 221 by the gauge feeder 22 is introduced. The contact region is provided with a heater 229c configured to heat the second ring-opening-polymerizable monomer and the compressive fluid fed. A same one as the contact region 9 in the polymerization reaction equipment 100 is used as the contact region 229.

The reaction region 233 is constituted by a pressure-tight tube or tubular device, and has an inlet 233a through which the first polymer product that is dissolved or melted as an intermediate is introduced, and an inlet 233b through which the second ring-opening-polymerizable monomer that is dissolved or melted in the contact region 229 is introduced. The inlet 233a is connected with the discharge outlet of the first polymerization reaction equipment 201 through a pressure-tight tube 230a. The discharge outlet of the first polymerization reaction equipment 201 means a discharge outlet such as an end of the tube or cylinder of the reaction region of the first polymerization reaction equipment 201, the gauge pump, and the pressure adjusting valve 16. In any case, the polymer product produced in the first polymerization reaction equipment 201 can be fed into the reaction region 233 without being returned to normal pressure.

At the other end of the reaction region 233, there is provided a complex discharge outlet through which a complex product obtained by polymerizing the first polymer product and the second ring-opening-polymerizable monomer is discharged. The reaction region 233 is provided with a heater 233c configured to heat the polymer product and second ring-opening-polymerizable monomer delivered, or the complex product obtained from the polymerization. In the present embodiment, a same one as the reaction region 13 in the polymerization reaction equipment 100 is used as the reaction region 233. The pressure adjusting valve 234 sends the complex product PP polymerized in the reaction region 233 to the outside of the reaction region 233 by utilizing a pressure difference between the inside and the outside of the reaction region 233.

It is also possible to obtain a complex product PP including three or more kinds of segments, by repeating the polymerization reaction equipment 202 shown in FIG. 5B in series.

In the first method, the first ring-opening-polymerizable monomer having the lower melting point (e.g., lactide) is polymerized in the first polymerization reaction equipment 201, and after the reaction is completed quantitatively, it is further polymerized with the second ring-opening-polymerizable monomer having the higher melting point (e.g., glycolide) in the second polymerization reaction equipment 202. This method is very useful, because it can advance the reaction at equal to or lower than the melting point of the ring-opening-polymerizable monomer in a state that there is little residual monomer, which makes it possible for a copolymer to be produced quantitatively.

### [[Second Method and Equipment]]

A polymer product production method as the second method includes a mixing step of mixing two or more kinds of polymer products continuously in the presence of a compressive fluid, and further includes other steps according to necessity. Examples of the two or more kinds of polymer products include a first polymer product obtained by polymerizing a first ring-opening-polymerizable monomer, and a second polymer product obtained by polymerizing a second ring-opening-polymerizable monomer.

A complex production equipment in the second method includes a mixer configured to mix two or more kinds of polymer products continuously in the presence of a compressive fluid, and includes other devices according to necessity. This complex production equipment is a tubular mixing vessel provided at one end thereof (at an upstream side) with two or more inlets through which the two or more kinds of polymer products are introduced, and at the other end thereof with a complex discharge outlet through which a complex obtained by mixing the two or more kinds of polymer products is discharged. It is preferable that the two or more inlets be connected with two or more discharge outlets of two or more polymer product production equipments, respectively. Production of a polymer product can be performed favorably with this complex production equipment.

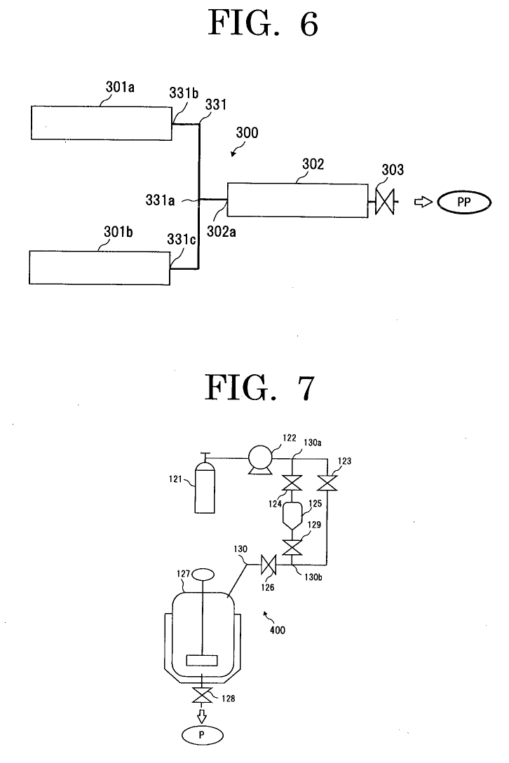

Next, the complex production equipment in the second method will be explained with reference to FIG. 6. FIG. 6 is an exemplary diagram showing the complex production equipment. The complex production equipment 300 includes polymerization reaction equipments (301a and 301b) having the same configuration as the polymerization reaction equipment 100, a mixer 302, and a pressure adjusting valve 303.

In the complex production equipment 300, a polymer product inlet 302a of the mixer 302 is connected with discharge outlets (331b and 331c) of the respective polymerization reaction equipments (301a and 301b) through a pressure-tight tube 331. The discharge outlets of the polymerization reaction equipments (301a and 301b) mean discharge outlets such as ends of the tubes or cylinders of the reaction regions, gauge pumps, and pressure adjusting valves. In any case, the polymer products P produced in the respective polymerization reaction equipments (301a and 301b) can be fed into the mixer 302 without being returned to normal pressure. As a result, the respective polymer products P are suppressed to a low viscosity in the presence of a compressive fluid, and hence the two or more kinds of polymer products can be mixed in the mixer 302 at a low temperature. FIG. 6 shows an example in which there are provided two polymerization reaction equipments (301a and 301b) in parallel, with the tube 331 having one joint 331a. There may be provided three or more polymerization reaction equipments in parallel, with a plurality of joints provided.

The mixer 302 is not particularly limited except that it should be able to mix a plurality of polymer products fed from the respective polymerization reaction equipments (301a and 301b). Examples of the mixer include a mixer having a stirrer. Preferable examples of the stirrer include a uniaxial screw, biaxial screws meshing with each other, a biaxial mixer including multiple stirring elements meshing or overlapping with one another, a kneader including spiral stirring elements meshing with each other, and a static mixer. The temperature for mixing the polymer products in the mixer 302 (a mixing temperature) may be set in the same manner as the polymerization reaction temperature in the reaction regions in the respective polymerization reaction equipments (301a and 301b). The mixer 302 may include a separate mechanism for feeding a compressive fluid to the polymer products to be mixed. The pressure adjusting valve 303 as an example of the complex discharge outlet is a device configured to adjust the flow rate of the complex product PP obtained through the polymer products being mixed in the mixer 302.

In the second method, a ring-opening-polymerizable monomer and another ring-opening polymerizable monomer (e.g., lactide and glycolide) are polymerized beforehand in the polymerization reaction equipment (301a and 301b) in the presence of a compressive fluid, respectively (a polymerization step). Then, the polymer products obtained from the polymerization are blended with each other in a compressive fluid, to thereby obtain a copolymer (a mixing step). Typically, a polymer product such as a polylactic acid tends to decompose upon being heated again to equal to or higher than a melting point thereof, even if the amount of residual polymer it includes is infinitely low. The second method is useful because a polylactic acid melted in a compressive fluid to have a low viscosity can be blended at a temperature equal to or lower than a melting point thereof at normal pressure, which makes it possible to suppress racemization and thermal degradation like the first method.

It is also possible to mix copolymers by combining the first method and the second method.

### Third Embodiment

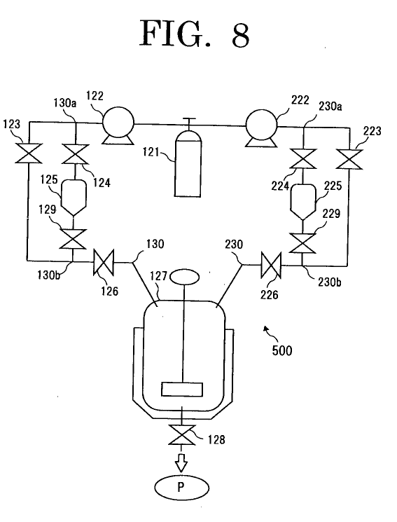

Next, a third embodiment will be explained in terms of differences from the first embodiment. In the third embodiment, a polymer product is produced through a batch-wise process. First, a polymerization reaction equipment 400 used in the batch-wise process will be explained with reference to FIG. 7. FIG. 7 is a system diagram showing a batch-wise polymerization step. In the system diagram of FIG. 7, the polymerization reaction equipment 400 includes a tank 121, a gauge pump 122, an addition pot 125, a reaction vessel 127, and valves (123, 124, 126, 128, and 129). These devices are connected with one another as shown in FIG. 7 through a pressure-tight tube 130. The tube 130 is provided with joints (130a and 130b).

The tank 121 stores a compressive fluid. The tank 121 may store a gas or a solid that turns to a compressive fluid by being heated or pressurized, through a process of being fed into the reaction vessel 127, or in the reaction vessel 127. In this case, the gas or the solid stored in the tank 121 comes to have the state of (1), (2), or (3) in the phase diagram of FIG. 2 in the reaction vessel 127, by being heated or pressurized.

The gauge pump 122 feeds the compressive fluid stored in the tank 121 into the reaction vessel 127 at a constant pressure at a constant flow rate. The addition pot 125 stores a catalyst to be added to the raw materials in the reaction vessel 127. The valves (123, 124, 126, and 129) are opened or closed to thereby switch between a path through which the compressive fluid stored in the tank 121 is fed into the reaction vessel 127 via the addition pot 125, and a path through which it is fed into the reaction vessel 127 without passing the addition pot 125.

A ring-opening-polymerizable monomer, an initiator, and a catalyst are put in the reaction vessel 127 in advance of polymerization being started. The reaction vessel 127 is a pressure-tight vessel in which the ring-opening-polymerizable monomer, the initiator, and the catalyst put in advance, the compressive fluid fed from the tank 121, the catalyst fed from the addition pot 125 are brought into contact with one another for the ring-opening-polymerizable monomer to be polymerized. The catalyst may be put in the reaction vessel 127 in advance. The reaction vessel 127 may have a gas outlet through which an evaporant is removed. The reaction vessel 127 includes a heater configured to heat the raw materials and the compressive fluid. The reaction vessel 127 also includes a stirrer configured to stir the raw materials and the compressive fluid. When there occurs a density difference between the raw materials and a polymer product produced, sedimentation of the produced polymer product can be suppressed with stirring by the stirrer, which makes it possible for the polymerization reaction to advance more uniformly and quantitatively. The valve 128 is opened after the polymerization reaction is completed, to thereby discharge the polymer product P in the reaction vessel 127.

Next, a method for practicing increasing the density of a compressive fluid during a reaction, which is employed in the present embodiment, in the batch-wise polymerization equipment will be explained. First, the gauge pump 122 is actuated to feed the compressive fluid into the reaction vessel 127 until the pressure in the reaction vessel becomes a predetermined pressure, and after this, a reaction is started with all the valves closed. Next, the gauge pump 122 is actuated to make the pressure from the gauge pump 122 to the valves 123 and 124 higher than the pressure in the reaction vessel 127. After this, the valve 123 is opened, and the pressure in the reaction vessel is raised with the gauge pump 122. After the pressure in the reaction vessel becomes a predetermined pressure, the gauge pump 122 is stopped and the valve 123 is closed. Through this process, it is possible to change the density of the compressive fluid during a reaction in the batch-wise equipment shown in FIG. 7. It is preferable to change the density of the compressive fluid by means of pressure as described above. However, it is also possible to increase the density of the compressive fluid by lowering the temperature in the reaction vessel 127.

### EXAMPLES

The present invention will be explained more specifically below, by presenting Examples and Comparative Examples. The present invention is not limited to these Examples and Comparative Examples by any means.

### Example 1-1

With the batch-wise polymerization reaction equipment 400 shown in FIG. 7, a mixture of L-lactide and D-lactide (L-lactide/D-lactide=90/10 (a mass ratio)) was ring-opening-polymerized. The configuration of the polymerization reaction equipment 400 is shown below.

Tank 21: a carbon dioxide bottle

Addition pot 125: a ¼ inch SUS316 tube was sandwiched between the valves (124 and 129) and used as the addition pot. The pot was filled beforehand with tin octylate, which was a catalyst, at a ratio of 500 ppm of a monomer.

Reaction vessel 127: a 100 mL pressure-tight vessel made of SUS316, filled beforehand with a mixture (54 g) of a liquid-state lactide (which was a mixture of L-lactide and D-lactide (at a mass ratio of 90/10)) (manufactured by Purac Biochem BV, a melting point: 100° C.), which was a ring-opening-polymerizable monomer, and a castor oil, which was an initiator (in the mixture, hydroxyl groups of the initiator was 0.7 mol relative to 100 mol of the monomer).

The castor oil was a castor oil-based polyol (URIC H-30) manufactured by Itoh Oil Chemicals Co., Ltd., which is a polyhydric alcohol obtained by modifying a castor oil. The same applies hereinafter.

In this experiment, the viscosity of the polymer during polymerization was suppressed by increasing the density of supercritical carbon dioxide during the polymerization. The details of the method will be described below.

The gauge pump 122 was actuated, and the valves (123 and 126) were opened, to thereby feed the carbon dioxide stored in the tank 121 into the reaction vessel 127 without passing the addition pot 125. After the space in the reaction vessel 127 was purged by the carbon dioxide, the valves (124 and 129) were opened to feed the tin octylate in the addition pot 125 into the reaction vessel 127. After this, when the temperature reached 150° C. and the pressure 10 MPa in the reaction vessel 127, the lactide was let to undergo a polymerization reaction for 30 minutes with all the valves closed. After this, in order for the polymerization density of the supercritical carbon dioxide to be increased for low-viscosity conditions to be produced, the gauge pump 122 was actuated such that the pressure from the gauge pump 122 to the valves 123 and 124 was raised. After the pressure became higher than the pressure in the reaction vessel 127, the valve 123 was opened. After this, the pressure was continued to be raised by means of the gauge pump 122. When the pressure reached 15 MPa, the reaction was advanced for 2 hours from that timing. In the descriptions and tables to be presented below, the initial polymerization conditions will be described as “temperature 1”, “pressure 1”, “polymerization density 1”, and “reaction time 1”, and the conditions after the pressure was raised will be described as “temperature 2”, “pressure 2”, “polymerization density 2”, and “reaction time 2”.

After the reaction was completed, the valve 128 was opened to return the temperature and pressure in the reaction vessel 127 gradually to normal temperature and normal pressure. The polymer product (a polylactic acid) in the reaction vessel 127 was extruded from an extrusion nozzle (not illustrated) in a strand shape and immersed in water of 10° C. Then, the strand was cut with a cutter and dried, to thereby obtain a pellet.

<Mixing Ratio [Raw Materials (g)/(Compressive Fluid+Raw Materials) (g)]>

The mixing ratio [raw materials/(compressive fluid+raw materials)] was calculated according to the following formula.

Spatial volume of supercritical carbon dioxide: 100 mL-54 g/1.27 (ratio of the raw materials)=57 mL

Mass of supercritical carbon dioxide: 57 mL×0.234 (ratio of the carbon dioxide at 150° C. and 15 MPa)=13.3

Mixing ratio: 54 g/(54 g+13.3=0.80

### <Polymerization Density>

The polymerization density was calculated from a polymerization temperature and pressure, using the following calculation program.

EOS-SCX VER. 0.2 W

A calculation program for calculating a density and a thermodynamic quantity according to an equation of state for water, ethanol, and carbon dioxide

Copyright© 2000-Tsutomu Ohmori

<Method for Calculating Branching degree of Branched Polyester>

The average branching degree of the pellet obtained in Example 1-1 was calculated according to Formula (1) below.

$$\begin{matrix}Bu = NOH \text{/} {N}^{′} \\ = ( OHV \times {10}^{- 3} \text{/} 56.1 ) \text{/} ( 1 \text{/} Mn ) \\ = OHV \times Mn \times {10}^{- 3} \text{/} 56.1\end{matrix} \qquad Formula ( 1 )$$

In the formula (1), Bu represents an average branching degree, NOH represents the number of hydroxyl groups per 1 g of branched polyester, N′ represents the number of molecules per 1 g of branched polyester, Mn represents a number average molecular weight, OHV represents a hydroxyl value of branched polyester, and 56.1 represents the molecular weight of potassium hydroxide.

Next, a residual monomer content, a weight average molecular weight, a molecular weight distribution, an impact strength, and a bending strength of the pellet obtained in Example 1-1 were evaluated in the manners described below. The results are shown in Table 1-1-1.

### <Molecular Weight of Polymer Product>

The molecular weight was measured by gel permeation chromatography (GPC) under the following conditions.
Instrument: GPC-8020 (manufactured by Tosoh Corporation)
Columns: TSK G2000HXL and G4000HXL (manufactured by Tosoh Corporation)
Temperature 40° C.
Solvent: chloroform
Flow rate: 1.0 mL/minute

A molecular weight distribution of the polymer product was measured under the conditions described above by injecting a sample having a concentration of 0.5% by mass (1 mL). A number average molecular weight (Mn) and a weight average molecular weight (Mw) of the polymer product were calculated from the obtained molecular weight distribution, using a molecular weight calibration curve generated based on a monodisperse polystyrene standard sample. The molecular weight distribution to be obtained was a value obtained by dividing Mw by Mn.

The polymer product of the present embodiment was substantially free from an organic solvent. Hence, it was excellent in safety and stability. In the present embodiment, an organic solvent means a solvent made of an organic substance that is liquid at normal temperature, does not chemically react with the solute, and is used as a reaction field. When the polymer product to be obtained through a ring-opening-polymerization reaction is a polylactic acid, examples of the organic solvent include chloroform, methylene chloride, toluene, and tetrahydrofuran. When it is said that the polymer product is substantially free from an organic solvent, it is meant that the content rate of the organic solvent in the polymer product measured according to a measuring method described below is less than the detection limit (5 ppm), specifically.

### <Method for Measuring Residual Organic Solvent>

2-propanol (2 parts by mass) was added to the measurement target polymer product (1 part by mass), and they were dispersed ultrasonically for 30 minutes. After this, the resultant was stored in a refrigerator (5° C.) for 1 day or longer, and then the organic solvent was extracted from the polymer product. The supernatant liquid was analyzed according to gas chromatography (GC-14A manufactured by Shimadzu Corporation), to quantitate the organic solvent and the residual monomer in the polymer product, to thereby measure the organic solvent concentration. The measurement conditions in the analysis were as follows.

Column: CBP20-M 50-0.25

Detector: FID

Amount of injection: from 1 μL to 5 μL

Carrier gas: He 2.5 kg/cm²

Hydrogen flow rate: 0.6 kg/cm²

Air flow rate: 0.5 kg/cm²

Chart speed: 5 mm/min

Sensitivity: Range101×Atten20

Column temperature: 40° C.

Injection Temp: 150° C.

### <Residual Monomer Content>

A residual monomer content in the obtained polymer product was obtained according to a residual monomer content measurement method described in “Voluntary standards for packaging, etc. with food containers made of synthetic resins such as polyolefins, third revision, supplemented in June 2004, part 3, a hygienic test method, P13”. Specifically, the polymer product such as a polylactic acid was dissolved uniformly in dichloromethane, and an acetone/cyclohexanone mixture solution was added thereto to thereby reprecipitate the polymer product. The resulting supernatant liquid was fed into a gas chromatograph (GC) equipped with a hydrogen flame detector (FID), to thereby separate the residual monomer. Quantitation was performed according to an internal reference method, to thereby measure the residual monomer content in the polymer product. The GC measurement was performed under the conditions described below. “ppm” in each table represents a mass fraction.

### <<GC Measurement Condition>>

Column: a capillary column (DB-17MS manufactured by J&W Technology Limited, a length of 30 m×an internal diameter of 0.25 mm, a film thickness of 0.25 μm)

Internal reference: 2,6-dimethyl-γ-pyrone

Column flow rate: 1.8 mL/minute

Column temperature: retained at 50° C. for 1 minute, raised at a constant rate of 25° C./minute, and retained at 320° C. for 5 minutes

Detector: a hydrogen flame ionization method (FID)

### <Impact Strength>

An impact strength was evaluated in the manner described below.

A 0.4 mm sheet was produced (a dissolution temperature during the production of the sheet was a heating temperature for calculation of Tm1). A weight of 200 g was let to fall onto the sheet, and the impact strength was evaluated based on the maximum height from which the test piece was not broken.

### [Evaluation Criteria]

A: 300 mm or greater

B: 150 mm or greater but less than 300 mm

C: 50 mm or greater but less than 150 mm

D: Less than 150 mm

Note that “Tm1” is a melting point obtained by subjecting a sample to a temperature raising process according to DSC.

### <Bending Strength Test>

A test was performed in the following manner, and the bending strength was evaluated based on the evaluation criteria described below.
Bending strength tester: manufactured by Instron Japan Company Limited
Test piece: a sheet of 50 mm×10 mm×1.5 mm was produced
Evaluated according to a three-point bending test
   Distance between two points supporting the test piece: 4 cm
   R value (radius) of a point to which a pressure is applied: 5 mm
   Pressure application rate: 10 mm/min

### [Evaluation Criteria]

A: 150 MPa or greater

B: 100 MPa or greater but less than 150 MPa

C: 50 MPa or greater but less than 100 MPa

D: Less than 50 MPa

### <Method for Measuring Melt Viscosity>

A melt viscosity was tested in the following manner, and evaluated based on the evaluation criteria described below.

Instrument: CPILLARY RHEOMETER CFT-100D (manufactured by Shimadzu Corporation)

### <<Temperature Raising Method>>

Temperature raising rate: 5.0 (° C./min)

Start temperature: 40° C.

Die hole diameter: 1.0 mm

Pre-heat time: 300 s

Melt viscosity value at 100° C.

### [Evaluation Criteria]

A: 500,000 Pa·s or greater

B: 100,000 Pa·s or greater but less than 500,000 Pa·s

C: Less than 100,000 Pa·s

### Examples 1-2 to 1-11

Polymer products of Examples 1-2 to 1-11 were produced in the same manner as in Example 1-1, except that the kind of the first monomer, the kind of the initiator, the kind of the catalyst, the amount of the catalyst, the amount of the initiator, the polymerization pressures 1 and 2, the polymerization reaction temperatures 1 and 2, the polymerization densities 1 and 2, the reaction times 1 and 2, whether or not to use an organic solvent, the mixing ratio [raw materials/(compressive fluid+raw materials)] ([R/(C+R)]), and the order to add the catalyst were determined as shown in Tables 1-1-1 and 1-1-2. In the case of late addition of the catalyst, the addition pot 125 was filled with the catalyst beforehand, and after the first monomer and the initiator in the reaction vessel 127 were mixed, the catalyst in the addition pot 125 was fed to the mixture.

A pellet of each of the obtained polymer products was produced with the same process as that in Example 1-1. The same evaluations as in Example 1-1 were performed. The results are shown in Tables 1-1-1 and 1-1-2.

### Examples 2-1 to 2-9

### Production of Sheet

Pellets were produced with the same process as that in Example 1-1, except that the kind of the first monomer, the kind of the initiator, the kind of the catalyst, the amount of the catalyst, the amount of the initiator, the polymerization pressures 1 and 2, the polymerization reaction temperatures 1 and 2, the polymerization densities 1 and 2, the reaction times 1 and 2, whether or not to use an organic solvent, the mixing ratio [raw materials/(compressive fluid+raw materials)] ([R/(C+R)]), and the order to add the catalyst were determined as shown in Tables 1-2-1 and 1-2-2. In the case of late addition of the catalyst, the addition pot 125 was filled with the catalyst beforehand, and after the first monomer and the second monomer in the reaction vessel 127 were mixed, the catalyst in the addition pot 125 was fed to the mixture.

Each of the obtained pellets was melt-extruded with a uniaxial extruder having a screw diameter of 90 mm and equipped with a T die having a width of 1,000 mm (SE-90CV manufactured by Toshiba Machine Co., Ltd.) at an extrusion temperature of 215° C., and then closely attached to a cast roll that was set to 40° C., to thereby obtain a sheet having a thickness of 350 μm.

### <Production of Sheet Molded Article>

Using each of the sheets obtained in the sheet production examples as a material, and using a hot plate pressure forming machine (an FKH-type small hot plate heating pressure molding machine manufactured by Asano Laboratories Co., Ltd.) and a molding die made of aluminum, a box-shaped container having a height of 250 mm, a width of 200 mm, and a depth of 30 mm was molded. The heating hot plate temperature (heating softening temperature) during molding was 120° C., the molding die surface temperature was 117° C., a heating time necessary for shape molding was 10 seconds, a cooling time was 5 seconds, and a shot cycle was 15 seconds. The molded semifinished product was punched with a punching blade using a Thomson blade, to thereby obtain a sheet molded article.

### <Evaluations of Sheet and Sheet Molded Article>

The obtained sheets and sheet molded articles were evaluated based on the criteria described below. Further, the obtained sheet molded articles were evaluated in the same manners as in Example 1-1. The results are shown in Tables 1-2-1 and 1-2-2. The reason why the pellet and molded article that were made of the same polymer product had different physical properties is considered to be due to influences of heat and pressure during shape molding.

### <<Evaluation of Sheet>>

A sample having a length of 1,000 mm and a width of 1,000 mm was observed visually, to confirm whether there were fish-eye heterogeneous products, and evaluate it based on the criteria below.

### [Evaluation Criteria]

A: There were no fish-eye heterogeneous products.

B: There were from 1 to 2 fish-eye heterogeneous products.

C: There were 3 or more fish-eye heterogeneous products.

### <<Evaluation of Sheet Molded Article>>

A hundred sheet molded article samples were produced, and shape-moldability during the sample production and appearance of the produced samples were evaluated based on the criteria below.

### [Evaluation Criteria]

A: Shape-moldability and appearance were non-problematic.

B: Shape-moldability, or appearance, or both was/were problematic slightly (one to nine samples were cracked during shape molding, or punching, or both, and they were slightly cloudy when observed visually).

C: Shape-moldability, or appearance, or both was/were problematic apparently (ten or more samples were cracked during shape molding, or punching, or both, and they were apparently cloudy when observed visually).

### Examples 3-1 to 3-6

Polymer products were produced with the same process as in Example 1-1, except that the kind of the first monomer, the kind of the initiator, the kind of the catalyst, the amount of the catalyst, the amount of the initiator, the polymerization pressures 1 and 2, the polymerization reaction temperatures 1 and 2, the polymerization densities 1 and 2, the reaction times 1 and 2, whether or not to use an organic solvent, the mixing ratio [raw materials/(compressive fluid+raw materials)] ([R/(C+R)]), and the order to add the catalyst were determined as shown in Tables 1-3-1 and 1-3-2.

The obtained polymer products were spun with a publicly-known simple melt spinning machine (CAPIROGRAPH 1D PMD-C manufactured by Toyo Seiki Seisaku-Sho, Limited), and stretched with a hot air stretching machine, to thereby obtain a monofilament. The obtained fiber was evaluated in the same manners as in Example 1-1. The results are shown in Tables 1-3-1 and 1-3-2.

### Examples 4-1 to 4-9

Polymer products were produced in the same manner as in Example 1-1, except that the kind of the first monomer, the kind of the initiator, the kind of the catalyst, the amount of the catalyst, the amount of the initiator, the polymerization pressures 1 and 2, the polymerization reaction temperatures 1 and 2, the polymerization densities 1 and 2, the reaction times 1 and 2, whether or not to use an organic solvent, the mixing ratio [raw materials/(compressive fluid+raw materials)] ([R/(C+R)]), and the order to add the catalyst were determined as shown in Tables 1-4-1 and 1-4-2.

The obtained polymer products were molded into a film having a thickness of 25 μm with a general-purpose inflation molding machine at a molding temperature of 250° C. Physical properties of the obtained stretched film as a polymer product were obtained in the manners described above. The results are shown in Tables 1-4-1 and 1-4-2.

### Example 5-1

In Example 5-1, the continuous polymerization reaction equipment 100 shown in FIG. 3 was used. The mixer in the contact region was a mixer including a biaxial stirrer mounted with screws meshing with each other, and having a cylinder internal diameter (d) of 30 mm. The two rotational axes were rotational in the same direction, and the rotational speed was 30 rpm. The reaction vessel of the reaction region 13 was a biaxial kneader (TME-18 manufactured by Toshiba Corporation).

A gear pump (gauge feeder 2) was actuated to volumetrically feed lactide in a melted state in the tank 1 to the mixer in the contact region 9. A gear pump (gauge feeder 4) was actuated to volumetrically feed a castor oil as an initiator in the tank 3 to the mixer in the contact region 9 in an amount of 0.7 mol % relative to the lactide. A gear pump (gauge feeder 6) was actuated to feed tin octylate in the tank 5 to the inlet 9b in an amount of 5,000 ppm relative to the lactide. The temperature of the cylinder of the mixer in the contact region 9 was 80° C. (temperature 1). A carbon dioxide gas was fed through a ventilation hole (inlet 9a) such that the pressure in the system would be 10 MPa.

The temperature of the cylinder of the reaction vessel of the reaction region 13 was 150° C. (temperature 2) in the vicinity of the raw material feeding portions and at the end. In order to increase the density of supercritical carbon dioxide, the pressure was raised with the pump 10 to 15 MPa. The average retention time of the reaction product in the vessel was 0.5 hour. After the reaction was completed, the polymer product was discharged while being decompressed. As a result, carbon dioxide was evaporated, and a polymer product was obtained. The obtained polymer product was a foamed product with the internal carbon dioxide evaporated. The obtained polymer product was pulverized with a counter jet mill (manufactured by Hosokawa Micron Ltd.) to thereby obtain particles having a volume average particle diameter of 6 μm. The obtained particles were evaluated in the same manners as in Example 1-1. The results are shown in Table 1-5.

### Example 5-2

A polymer product was produced with the same process as in Example 5-1, except that the kind of the first monomer, the kind of the initiator, the kind of the catalyst, the amount of the catalyst, the amount of the initiator, the polymerization pressures 1 and 2, the polymerization reaction temperatures 1 and 2, the polymerization densities 1 and 2, the reaction times 1 and 2, whether or not to use an organic solvent, the mixing ratio [raw materials/(compressive fluid+raw materials)] ([R/(C+R)]), and the order to add the catalyst were determined as shown in Table 1-5. In the case of late addition of the catalyst, a gear pump (gauge feeder 12) was actuated to feed tin octylate in the tank 11 to the inlet 13b in an amount of 5,000 ppm relative to the first monomer. The obtained particles were evaluated in the same manners as in Example 1-1. The results are shown in Table 1-5.

### Example 6-1

With a polymerization reaction equipment 500 shown in FIG. 8, and using a castor oil as an initiator, a polylactic acid-glycolide copolymer was produced. FIG. 8 was a system diagram showing an example of a batch-wise polymerization step. The polymerization reaction equipment 500 had the same configuration as that of the polymerization reaction equipment 400 shown in FIG. 7, except that it included a tube 230 provided with a gauge pump 222, an addition pot 225, valves (223, 224, 226, and 229) and joints (230a and 230b). The gauge pump 222, the addition pot 225, the valves (223, 224, 226, and 229), and the tube 230 were constituted by the same device, mechanism, or unit as that of the gauge pump 122, the addition pot 125, the valves (123, 124, 126, and 129), and the tube 130.

The configuration of the polymerization reaction equipment 500 was as follows.
Tank 121: a carbon dioxide bottle
Addition pot 125: a ¼ inch SUS316 tube was sandwiched between the valves (124 and 129) and used as the addition pot.
Addition pot 225: a ¼ inch SUS316 tube was sandwiched between the valves (224 and 229) and used as the addition pot. The pot was filled beforehand with a mixture (54 g) of the first monomer (glycolide) having the higher melting point of the raw materials, and an initiator (a castor oil) (at a molar ratio: glycolide/initiator=99/1).
Reaction vessel 127: a 100 mL pressure-tight vessel made of SUS316 was used. It was filled beforehand with a mixture (54 g) of the second monomer (lactide) having the lowest melting point of the raw materials, and an initiator (a castor oil) (in the mixture, hydroxyl groups of the initiator was 0.5 mol relative to 100 mol of the monomer).

In Example 6-1, the addition pot 125 was filled beforehand with tin octylate in an amount of 5,000 ppm relative to the ring-opening-polymerizable monomers as the raw materials.

After the raw material in the reaction vessel 127 was heated to 60° C., supercritical carbon dioxide (60° C., 10 MPa) was filled into the reaction vessel with the gauge pump 122, to melt the raw material for 10 minutes while stirring it. After the temperature in the system was adjusted to 150° C., the path of the compressive fluid was switched to the path via the addition pot 125. In this way, the catalyst filled beforehand in the addition pot 125 was pushed and added into the reaction vessel 127 from the addition pot 125 at a set pressure that was higher than the pressure in the reaction vessel 127. After this, the ring-opening-polymerizable monomer having the lower melting temperature was polymerized for 2 hours.

Next, the path of the compressive fluid was switched to the path via the addition pot 225. In this way, the ring-opening-polymerizable monomer having the higher melting point filled beforehand in the addition pot 225 was pushed and added into the reaction vessel 127 from the addition pot 225 at a set pressure that was higher than the pressure in the reaction vessel 127. After this, in order to increase the density of the supercritical carbon dioxide, the pressure was raised with the pump 222 to a pressure of 15 MPa, and the ring-opening-polymerizable monomer having the higher temperature was polymerized for 2 hours from when the pressure reached that level.

After the reaction was completed, the polymer product was discharged while being decompressed with the valve 128. As a result, carbon dioxide was evaporated, and a polymer product was obtained. The obtained polymer product was a foamed product with the internal carbon dioxide evaporated. The obtained polymer product was pulverized with a counter jet mill (manufactured by Hosokawa Micron Ltd.) to thereby obtain particles having a volume average particle diameter of from 1 μm to 50 μm. Physical properties of the obtained particles as a polymer product were obtained in the manners described above. The results are shown in Table 1-6-1.

### Examples 6-2 to 6-6

Polymer products of Examples 6-2 to 6-6 were produced with the same process as Example 6-1, except that the kind of the first monomer, the kind of the initiator, the kind of the catalyst, the amount of the catalyst, the amount of the initiator, the polymerization pressures 1 and 2, the polymerization reaction temperatures 1 and 2, the polymerization densities 1 and 2, the reaction times 1 and 2, whether or not to use an organic solvent, the mixing ratio [raw materials/(compressive fluid+raw materials)] ([R/(C+R)]), and the order to add the catalyst were determined as shown in Tables 1-6-1 and 1-6-2. In the case of early addition of the catalyst, the reaction vessel 127 was filled beforehand with the catalyst. The pressure was controlled by changing the flow rate of the pump. The same evaluations as in Example 6-1 were performed. The results are shown in Tables 1-6-1 and 1-6-2.

### Examples 6-7 to 6-9

Mevalonolactone is a ring-opening-polymerizable monomer, and has a hydroxyl group. Therefore, it would function as an initiator and provide a branching point. There are polymerization methods in which mevalonolactone is made to function efficiently as a branching point. In one such polymerization method (6-1), a castor oil as an initiator and mevalonolactone are melted beforehand in the reaction vessel 127, the catalyst in the addition pot 225 is added thereto to start polymerization, and after this, lactide is added from the addition pot 125 and polymerized. In another such polymerization method (6-2), lactide and mevalonolactone are melted in the reaction vessel 127 beforehand, and the catalyst is added thereto from the addition pot 125, to start polymerization. Polymerization was performed in any of the two methods described above. In any Example that includes a description about the initiator in Table 1-6-2, the polymerization method 6-1 was employed. In any Example that includes no description about the initiator in Table 1-6-2, the polymerization method 6-2 was employed.

Particles of each of the obtained polymer products were produced with the same process as that in Example 6-1. Further, the same evaluations as in Example 6-1 were performed. The results are shown in Table 1-6-2.

### Example 6-10

The same process as in Example 6-2 was performed except that the conditions described below were used unlike in Example 6-2.

A castor oil as an initiator and lactide-1 were melted, and a catalyst in the addition pot 225 was added thereto to start polymerization. After this, lactide-2 and mevalonolactone were added from the addition pot 125 and polymerized. With a view to disposing branching units outside a molecule, polymerization of lactides was performed in the first stage, and branching units were introduced in the second stage.

The mole number of the castor oil relative to the total mole number of the lactide-1, the lactide-2, and mevalonolactone was 0.5%. The total additive amount thereof was 54 g, at a molar ratio lactide-1:lactide-2:mevalonolactone of 5:4.9:0.1.

The results are shown in Table 1-6-3.

### Examples 6-11 to 6-13

Polymer products of Examples 6-11 to 6-13 were produced with the same process as in Example 6-10, except that the kind of the catalyst and the kind of the initiator were determined as shown in Table 1-6-3.

### Comparative Example 1-1

A reaction vessel equipped with a mixer was charged with a lactide, a lauryl alcohol as an initiator, and dichloromethane under the conditions shown in Table 1-7, and they were stirred for 1 hour. After this, tin octylate as a catalyst was added, and the materials were reacted at room temperature (25° C.) for 24 hours, to thereby obtain a polylactic acid. The same evaluations as in Example 1-1 were performed. The results are shown in Table 1-7.

### Comparative Examples 1-2 to 1-6

Polylactic acids were obtained by performing polymerization in the same manner as in Comparative Example 1-1, except that the kind of the initiator, the amount of the initiator, and the reaction time were changed to the conditions shown in Tables 1-7 and 1-8. The same evaluations as in Example 1-1 were performed. The results are shown in Tables 1-7 and 1-8.

### Comparative Examples 2-1 to 2-2

Polylactic acids were obtained by performing polymerization in the same manner as in Example 1-1, except that the kind of the initiator, and the mount of the initiator were changed to the conditions shown in Table 1-9, and the pressure was maintained constant at 15 MPa throughout the reaction time of 2 hours. The same evaluations as in Example 1-1 were performed. The results are shown in Table 1-9.

TABLE 1-1-1

| | Examples | | | | | | |
|---|---|---|---|---|---|---|---|
| | 1-1 | 1-2 | 1-3 | 1-4 | 1-5 | 1-6 | 1-7 |
| First | Lactide | Lactide | Lactide | Lactide | Glycolide | p-dioxanone | Propiolactone |
| monomer | | | | | | | |
| Initiator | Castor | Castor | Castor | Castor | Ditrimethylol | Diglycerin | Glycerin |
| | oil | oil | oil | oil | propane | | |
| Amount of | 0.7 | 0.7 | 0.2 | 0.7 | 0.7 | 0.7 | 0.7 |
| initiator | | | | | | | |
| (mol %) | | | | | | | |
| Catalyst | Sn | Sn | Sn | DBU | Sn | Sn | Sn |
| Amount of | 5,000 | 5,000 | 5,000 | 500 | 5,000 | 5,000 | 5,000 |
| catalyst (ppm) | | | | | | | |
| Organic | None | None | None | None | Toluene | None | None |
| solvent | | | | | 1 mol % | | |
| Temperature 1 | 150 | 150 | 150 | 60 | 100 | 100 | 150 |
| (° C.) | | | | | | | |
| Pressure 1 | 10 | 8 | 15 | 10 | 10 | 10 | 10 |
| (Mpa) | | | | | | | |
| Polymerization | 146 | 113 | 234 | 290 | 189 | 189 | 146 |
| density 1 | | | | | | | |
| (kg/m³) | | | | | | | |
| Reaction time | 0.5 | 0.5 | 0.5 | 0.5 | 0.5 | 0.5 | 0.5 |
| 1 (h) | | | | | | | |
| Temperature 2 | 150 | 150 | 150 | 40 | 100 | 100 | 150 |
| (° C.) | | | | | | | |
| Pressure 2 | 15 | 10 | 65 | 15 | 15 | 50 | 15 |
| (MPa) | | | | | | | |
| Polymerization | 213 | 146 | 771 | 780 | 332 | 819 | 213 |
| density 2 | | | | | | | |
| (kg/m³) | | | | | | | |
| Reaction time | 2 | 2 | 2 | 2 | 0.5 | 0.5 | 2 |
| 2 (h) | | | | | | | |
| R/(C + R) | 0.8 | 0.8 | 0.8 | 0.61 | 0.8 | 0.8 | 0.8 |
| Weight ave. | 220,000 | 200,000 | 450,000 | 210,000 | 210,000 | 350,000 | 210,000 |
| molecular | | | | | | | |
| weight | | | | | | | |
| Mw/Mn | 1.6 | 1.4 | 1.5 | 1.6 | 1.9 | 2.1 | 1.7 |
| Average | 3.2 | 3.5 | 4.8 | 5 | 4.2 | 6.9 | 7.6 |
| branching | | | | | | | |
| degree | | | | | | | |
| Residual | 400 | 1,100 | 900 | 3,000 | 2,400 | 400 | 3,500 |
| monomer | | | | | | | |
| content (ppm) | | | | | | | |
| Catalyst | Early | Late | Late | Late | Early | Early | Early |
| addition | | | | | | | |
| Impact | A | B | A | A | A | A | B |
| strength | | | | | | | |
| Bending | A | A | B | B | B | B | B |
| strength | | | | | | | |
| Melt viscosity | A | A | A | B | A | B | A |

TABLE 1-1-2

| | Examples | | | |
|---|---|---|---|---|
| | 1-8 | 1-9 | 1-10 | 1-11 |
| First | δ-valerolactone | ε-caprolactone | Lactide | lactide |
| monomer | | | | |
| Initiator | Trimethylol | Trimethylol | Polyvinyl | Polyvinyl |
| | propane | ethane | alcohol | alcohol |
| Amount of | 0.7 | 0.7 | 0.5% by | 0.5% by |
| initiator | | | mass | mass |
| (mol %) | | | | |
| Catalyst | Sn | Sn | Sn | DBU |
| Amount of | 5,000 | 5,000 | 500 | 2,500 |
| catalyst (ppm) | | | | |
| Organic | None | Toluene | None | None |
| solvent | | 1 mol % | | |
| Temperature | 150 | 150 | 190 | 60 |
| 1 (° C.) | | | | |
| Pressure 1 | 10 | 10 | 10 | 10 |
| (Mpa) | | | | |
| Polymerization | 146 | 146 | 126 | 290 |
| density 1 | | | | |
| (kg/m³) | | | | |
| Reaction time | 0.5 | 0.5 | 2 | 0.5 |
| 1 (h) | | | | |
| Temperature | 150 | 150 | 150 | 40 |
| 2 (° C.) | | | | |
| Pressure 2 | 15 | 15 | 15 | 15 |
| (MPa) | | | | |
| Polymerization | 213 | 213 | 233 | 780 |
| density 2 | | | | |
| (kg/m³) | | | | |
| Reaction time | 2 | 2 | 2 | 2 |
| 2 (h) | | | | |
| R/(C + R) | 0.8 | 0.8 | 0.8 | 0.8 |
| Weight ave. | 230,000 | 220,000 | 250,000 | 210,000 |
| molecular | | | | |
| weight | | | | |
| Mw/Mn | 1.5 | 1.6 | 2.1 | 1.9 |
| Average | 8.2 | 7.9 | 37 | 41 |
| branching | | | | |
| degree | | | | |
| Residual | 3,300 | 4,500 | 4,600 | 2,000 |
| monomer | | | | |
| content (ppm) | | | | |
| Catalyst | Late | Early | Early | Late |
| addition | | | | |
| Impact | A | B | A | A |
| strength | | | | |
| Bending | B | B | A | B |
| strength | | | | |
| Melt viscosity | B | A | A | B |

In Examples 1-10 and 1-11, a polyvinyl alcohol (MN2000 manufactured by Tokyo Chemical Industry Co., Ltd., with a saponification degree of 80%) was used as an initiator in an amount of 0.5% by mass relative to lactide. The same applies to polyvinyl alcohols to be used hereinafter.

TABLE 1-2-1

| | Examples | | | | |
|---|---|---|---|---|---|
| | 2-1 | 2-2 | 2-3 | 2-4 | 2-5 |
| First | Lactide | Lactide | Lactide | Lactide | Glycolide |
| monomer | | | | | |
| Initiator | Castor oil | Castor oil | Castor oil | Castor oil | Ditrimethylol |
| | | | | | propane |
| Amount of | 0.7 | 0.7 | 0.2 | 0.7 | 0.7 |
| initiator | | | | | |
| (mol %) | | | | | |
| Catalyst | Sn | Sn | Sn | DBU | Sn |
| Amount of | 5,000 | 5,000 | 5,000 | 500 | 5,000 |
| catalyst (ppm) | | | | | |
| Organic | None | None | None | None | Toluene |
| solvent | | | | | 1 mol % |
| Temperature 1 | 150 | 150 | 150 | 60 | 100 |
| (° C.) | | | | | |
| Pressure 1 | 10 | 8 | 15 | 10 | 10 |
| (Mpa) | | | | | |
| Polymerization | 146 | 113 | 234 | 290 | 189 |
| density 1 | | | | | |
| (kg/m³) | | | | | |
| Reaction time | 0.5 | 0.5 | 0.5 | 0.5 | 0.5 |
| 1 (h) | | | | | |
| Temperature 2 | 150 | 150 | 150 | 40 | 100 |
| (° C.) | | | | | |
| Pressure 2 | 15 | 10 | 65 | 15 | 15 |
| (MPa) | | | | | |
| Polymerization | 213 | 146 | 771 | 780 | 332 |
| density 2 | | | | | |
| (kg/m³) | | | | | |
| Reaction time | 2 | 2 | 2 | 2 | 0.5 |
| 2 (h) | | | | | |
| R/(C + R) | 0.8 | 0.8 | 0.8 | 0.61 | 0.8 |
| Weight ave. | 200,000 | 210,000 | 430,000 | 200,000 | 200,000 |
| molecular | | | | | |
| weight | | | | | |
| Mw/Mn | 1.6 | 1.4 | 1.5 | 1.6 | 1.9 |
| Average | 3.2 | 3.5 | 4.8 | 5 | 4.2 |
| branching | | | | | |
| degree | | | | | |
| Residual | 400 | 1,100 | 900 | 3,000 | 2,400 |
| monomer | | | | | |
| content (ppm) | | | | | |
| Catalyst | Early | Late | Late | Late | Early |
| addition | | | | | |
| Impact | A | B | A | A | B |
| strength | | | | | |
| Bending | A | A | B | B | B |
| strength | | | | | |
| Melt viscosity | A | A | A | B | A |
| Sheet evaluation | A | A | A | B | A |
| Sheet molding | B | B | B | B | B |
| evaluation | | | | | |

TABLE 1-2-2

| | Examples | | | |
|---|---|---|---|---|
| | 2-6 | 2-7 | 2-8 | 2-9 |
| First | P-dioxanone | Propiolactone | δ-valerolactone | ε-caprolactone |
| monomer | | | | |
| Initiator | Diglycerin | Glycerin | Trimethylol | Trimethylol |
| | | | propane | ethane |
| Amount of | 0.7 | 0.7 | 0.7 | 0.7 |
| initiator | | | | |
| (mol %) | | | | |
| Catalyst | Sn | Sn | Sn | Sn |
| Amount of | 5,000 | 5.000 | 5,000 | 5,000 |
| catalyst | | | | |
| (ppm) | | | | |
| Organic | None | None | None | Toluene 1 |
| solvent | | | | mol % |
| Temperature | 100 | 150 | 150 | 150 |
| 1 (° C.) | | | | |
| Pressure 1 | 10 | 10 | 10 | 10 |
| (Mpa) | | | | |
| Poly- | 189 | 146 | 146 | 146 |
| merization | | | | |
| density 1 | | | | |
| (kg/m³) | | | | |
| Reaction time | 0.5 | 0.5 | 0.5 | 0.5 |
| 1 (h) | | | | |
| Temperature | 100 | 150 | 150 | 150 |
| 2 (° C.) | | | | |
| Pressure 2 | 50 | 15 | 15 | 15 |
| (MPa) | | | | |
| Poly- | 819 | 213 | 213 | 213 |
| merization | | | | |
| density 2 | | | | |
| (kg/m³) | | | | |
| Reaction time | 0.5 | 2 | 2 | 2 |
| 2 (h) | | | | |
| R/(C + R) | 0.8 | 0.8 | 0.8 | 0.8 |
| Weight ave. | 330,000 | 210,000 | 230,000 | 240,000 |
| molecular | | | | |
| weight | | | | |
| Mw/Mn | 2.1 | 1.7 | 1.5 | 1.6 |
| Average | 6.9 | 7.6 | 8.2 | 7.9 |
| branching | | | | |
| degree | | | | |
| Residual | 400 | 3,500 | 3,300 | 4,500 |
| monomer | | | | |
| content | | | | |
| (ppm) | | | | |
| Catalyst | Early | Early | Late | Early |
| addition | | | | |
| Impact | B | B | B | B |
| strength | | | | |
| Bending | B | B | B | B |
| strength | | | | |
| Melt | B | A | B | A |
| viscosity | | | | |
| Sheet | A | B | B | B |
| evaluation | | | | |
| Sheet | B | B | B | B |
| molding | | | | |
| evaluation | | | | |

TABLE 1-3-1

| | Examples | | | | |
|---|---|---|---|---|---|
| | 3-1 | 3-2 | 3-3 | 3-4 | 3-5 |
| First | Lactide | Lactide | Lactide | Lactide | Glycolide |
| monomer | | | | | |
| Initiator | Castor oil | Castor oil | Castor oil | Castor oil | Ditrimethylol |
| | | | | | propane |
| Amount of | 0.7 | 0.7 | 0.2 | 0.7 | 0.7 |
| initiator | | | | | |
| (mol %) | | | | | |
| Catalyst | Sn | Sn | Sn | DBU | Sn |
| Amount of | 5,000 | 5,000 | 5,000 | 500 | 5,000 |
| catalyst (ppm) | | | | | |
| Organic | None | None | None | None | Toluene |
| solvent | | | | | 1 mol % |
| Temperature 1 | 150 | 150 | 150 | 60 | 100 |
| (° C.) | | | | | |
| Pressure 1 | 10 | 8 | 15 | 10 | 10 |
| (Mpa) | | | | | |
| Polymerization | 146 | 113 | 234 | 290 | 189 |
| density 1 | | | | | |
| (kg/m³) | | | | | |
| Reaction time | 0.5 | 0.5 | 0.5 | 0.5 | 0.5 |
| 1 (h) | | | | | |
| Temperature 2 | 150 | 150 | 150 | 40 | 100 |
| (° C.) | | | | | |
| Pressure 2 | 15 | 10 | 65 | 15 | 15 |
| (MPa) | | | | | |
| Polymerization | 213 | 146 | 771 | 780 | 332 |
| density 2 | | | | | |
| (kg/m³) | | | | | |
| Reaction time | 2 | 2 | 2 | 2 | 0.5 |
| 2 (h) | | | | | |
| R/(C + R) | 0.8 | 0.8 | 0.8 | 0.61 | 0.8 |
| Weight ave. | 220,000 | 220,000 | 430,000 | 210,000 | 210,000 |
| molecular | | | | | |
| weight | | | | | |
| Mw/Mn | 1.6 | 1.4 | 1.5 | 1.6 | 1.9 |
| Average | 3.2 | 3.5 | 4.8 | 5 | 4.2 |
| branching | | | | | |
| degree | | | | | |
| Residual | 400 | 1,100 | 900 | 3,000 | 2,400 |
| monomer | | | | | |
| content (ppm) | | | | | |
| Catalyst | Early | Late | Late | Late | Early |
| addition | | | | | |
| Melt viscosity | A | A | A | B | A |

TABLE 1-3-2

| | Examples | | | |
|---|---|---|---|---|
| | 3-6 | 3-7 | 3-8 | 3-9 |
| First | p-dioxanone | Propiolactone | δ-valerolactone | ε-caprolactone |
| monomer | | | | |
| Initiator | Diglycerin | Glycerin | Trimethylol | Trimethylol |
| | | | propane | ethane |
| Amount of | 0.7 | 0.7 | 0.7 | 0.7 |
| initiator | | | | |
| (mol %) | | | | |
| Catalyst | Sn | Sn | Sn | Sn |
| Amount of | 5,000 | 5,000 | 5,000 | 5,000 |
| catalyst | | | | |
| (ppm) | | | | |
| Organic | None | None | None | Toluene 1 |
| solvent | | | | mol % |
| Temper- | 100 | 150 | 150 | 150 |
| ature | | | | |
| 1 (° C.) | | | | |
| Pressure 1 | 10 | 10 | 10 | 10 |
| (Mpa) | | | | |
| Poly- | 189 | 146 | 146 | 146 |
| merization | | | | |
| density 1 | | | | |
| (kg/m³) | | | | |
| Reaction | 0.5 | 0.5 | 0.5 | 0.5 |
| time 1 (h) | | | | |
| Temper- | 100 | 150 | 150 | 150 |
| ature | | | | |
| 2 (° C.) | | | | |
| Pressure 2 | 50 | 15 | 15 | 15 |
| (MPa) | | | | |
| Poly- | 819 | 213 | 213 | 213 |
| merization | | | | |
| density 2 | | | | |
| (kg/m³) | | | | |
| Reaction | 0.5 | 2 | 2 | 2 |
| time 2 (h) | | | | |
| R/(C + R) | 0.8 | 0.8 | 0.8 | 0.8 |
| Weight ave. | 330,000 | 210,000 | 230,000 | 240,000 |
| molecular | | | | |
| weight | | | | |
| Mw/Mn | 2.1 | 1.7 | 1.5 | 1.6 |
| Average | 6.9 | 7.6 | 8.2 | 7.9 |
| branching | | | | |
| degree | | | | |
| Residual | 400 | 3,500 | 3,300 | 4,500 |
| monomer | | | | |
| content | | | | |
| (ppm) | | | | |
| Catalyst | Early | Early | Late | Early |
| addition | | | | |
| Melt | B | A | B | A |
| viscosity | | | | |

TABLE 1-4-1

| | Examples | | | | |
|---|---|---|---|---|---|
| | 4-1 | 4-2 | 4-3 | 4-4 | 4-5 |
| First | Lactide | Lactide | Lactide | Lactide | Lactide |
| monomer | | | | | |
| Initiator | Castor oil | Castor oil | Castor oil | Castor oil | Ditrimethylol |
| | | | | | propane |
| Amount of | 0.7 | 0.7 | 0.2 | 0.7 | 0.7 |
| initiator | | | | | |
| (mol %) | | | | | |
| Catalyst | Sn | Sn | Sn | DBU | Sn |
| Amount of | 5,000 | 5,000 | 5,000 | 500 | 5,000 |
| catalyst (ppm) | | | | | |
| Organic | None | None | None | None | Toluene |
| solvent | | | | | 1 mol % |
| Temperature 1 | 150 | 150 | 150 | 60 | 150 |
| (° C.) | | | | | |
| Pressure 1 | 10 | 8 | 15 | 10 | 10 |
| (Mpa) | | | | | |
| Polymerization | 146 | 113 | 234 | 290 | 189 |
| density 1 | | | | | |
| (kg/m³) | | | | | |
| Reaction time | 0.5 | 0.5 | 0.5 | 0.5 | 0.5 |
| 1 (h) | | | | | |
| Temperature 2 | 150 | 150 | 150 | 40 | 100 |
| (° C.) | | | | | |
| Pressure 2 | 15 | 10 | 65 | 15 | 15 |
| (MPa) | | | | | |
| Polymerization | 213 | 146 | 771 | 780 | 213 |
| density 2 | | | | | |
| (kg/m³) | | | | | |
| Reaction time | 2 | 2 | 2 | 2 | 2 |
| 2 (h) | | | | | |
| R/(C + R) | 0.8 | 0.8 | 0.8 | 0.61 | 0.8 |
| Weight ave. | 220,000 | 220,000 | 440,000 | 210,000 | 210,000 |
| molecular | | | | | |
| weight | | | | | |
| Mw/Mn | 1.6 | 1.4 | 1.5 | 1.6 | 1.9 |
| Average | 3.2 | 3.5 | 4.8 | 5.0 | 4.2 |
| branching | | | | | |
| degree | | | | | |
| Residual | 400 | 1,100 | 900 | 3,000 | 2,400 |
| monomer | | | | | |
| content (ppm) | | | | | |
| Catalyst | Early | Late | Late | Late | Early |
| addition | | | | | |
| Melt viscosity | A | A | A | B | A |

TABLE 1-4-2

| | Examples | | | |
|---|---|---|---|---|
| | 4-6 | 4-7 | 4-8 | 4-9 |
| First | Lactide | Propiolactone | δ-valerolactone | ε-caprolactone |
| monomer | | | | |
| Initiator | Diglycerin | Glycerin | Trimethylol | Trimethylol |
| | | | propane | ethane |
| Amount of | 0.7 | 0.7 | 0.7 | 0.7 |
| initiator | | | | |
| (mol %) | | | | |
| Catalyst | Sn | Sn | Sn | Sn |
| Amount of | 5,000 | 5,000 | 5,000 | 5,000 |
| catalyst (ppm) | | | | |
| Organic | None | None | None | Toluene 1 |
| solvent | | | | mol % |
| Temperature 1 | 150 | 150 | 150 | 150 |
| (° C.) | | | | |
| Pressure 1 | 10 | 10 | 10 | 10 |
| (Mpa) | | | | |
| Polymerization | 189 | 146 | 146 | 146 |
| density 1 | | | | |
| (kg/m³) | | | | |
| Reaction time | 0.5 | 0.5 | 0.5 | 0.5 |
| 1 (h) | | | | |
| Temperature 2 | 100 | 150 | 150 | 150 |
| (° C.) | | | | |
| Pressure 2 | 50 | 15 | 15 | 15 |
| (MPa) | | | | |
| Polymerization | 819 | 213 | 213 | 213 |
| density 2 | | | | |
| (kg/m³) | | | | |
| Reaction time | 0.5 | 2 | 2 | 2 |
| 2 (h) | | | | |
| R/(C + R) | 0.8 | 0.8 | 0.8 | 0.8 |
| Weight ave. | 320,000 | 210,000 | 230,000 | 240,000 |
| molecular | | | | |
| weight | | | | |
| Mw/Mn | 1.6 | 1.7 | 1.5 | 1.6 |
| Average | 6.9 | 7.6 | 8.2 | 7.9 |
| branching | | | | |
| degree | | | | |
| Residual | 400 | 3,500 | 3,300 | 4,500 |
| monomer | | | | |
| content (ppm) | | | | |
| Catalyst | Early | Early | Late | Early |
| addition | | | | |
| Melt viscosity | B | A | B | A |

TABLE 1-5

Examples

| | 5-1 | 5-2 |
|---|---|---|
| First | Lactide | Lactide |
| monomer | | |
| Initiator | Castor oil | Castor oil |
| Amount of | 0.7 | 0.7 |
| initiator | | |
| (mol %) | | |
| Catalyst | Sn | Sn |
| Amount of | 5,000 | 5,000 |
| catalyst (ppm) | | |
| Organic | None | None |
| solvent | | |
| Temperature 1 | 80 | 80 |
| (° C.) | | |
| Pressure 1 | 10 | 8 |
| (Mpa) | | |
| Polymerization | 146 | 113 |
| density 1 | | |
| (kg/m³) | | |
| Reaction time | 0.5 | 0.5 |
| 1 (h) | | |
| Temperature 2 | 150 | 150 |
| (° C.) | | |
| Pressure 2 | 15 | 10 |
| (MPa) | | |
| Polymerization | 213 | 146 |
| density 2 | | |
| (kg/m³) | | |
| Reaction time | 0.5 | 0.5 |
| 2 (h) | | |
| R/(C + R) | 0.8 | 0.8 |
| Weight ave. | 210,000 | 210,000 |
| molecular | | |
| weight | | |
| Mw/Mn | 1.7 | 1.5 |
| Average | 3.2 | 5.3 |
| branching | | |
| degree | | |
| Residual | 2,000 | 2,500 |
| monomer | | |
| content (ppm) | | |
| Catalyst | Early | Late |
| addition | | |
| Melt viscosity | A | A |

TABLE 1-6-1

| | Examples | | | | |
|---|---|---|---|---|---|
| | 6-1 | 6-2 | 6-3 | 6-4 | 6-5 |
| First | Glycolide | | | | Lactide |
| monomer | | | | | |
| Initiator | Castor oil | | | Glycerin | Trimethylol |
| | | | | | propane |
| Second | Lactide | | | | ε-caprolactone |
| monomer | | | | | |
| Catalyst | Sn | Sn | Sn | DMAP | Sn |
| Amount of | 5,000 | 5,000 | 5,000 | 500 | 5,000 |
| catalyst (ppm) | | | | | |
| Amount of | 0.5 | 0.2 | 0.5 | 0.2 | 0.5 |
| initiator | | | | | |
| (mol %) | | | | | |
| Organic | None | None | None | None | Toluene |
| solvent | | | | | 1 mol % |
| Temperature 1 | 150 | 150 | 150 | 60 | 100 |
| (° C.) | | | | | |
| Pressure 1 | 10 | 8 | 15 | 10 | 10 |
| (Mpa) | | | | | |
| Polymerization | 146 | 113 | 234 | 290 | 189 |
| density 1 | | | | | |
| (kg/m³) | | | | | |
| Reaction time | 0.5 | 0.5 | 0.5 | 0.5 | 0.5 |
| 1 (h) | | | | | |
| Temperature 2 | 150 | 150 | 150 | 40 | 100 |
| (° C.) | | | | | |
| Pressure 2 | 15 | 10 | 65 | 15 | 15 |
| (MPa) | | | | | |
| Polymerization | 213 | 146 | 771 | 780 | 332 |
| density 2 | | | | | |
| (kg/m³) | | | | | |
| Reaction time | 2 | 2 | 2 | 2 | 2 |
| 2 (h) | | | | | |
| R/(C + R) | 0.2 | 0.72 | 0.2 | 0.72 | 0.18 |
| Amount of | 13 | 9 | 10.5 | 7.4 | 13 |
| oxide unit | | | | | |
| (mol %) | | | | | |
| Weight ave. | 230,000 | 340,000 | 450,000 | 200,000 | 350,000 |
| molecular | | | | | |
| weight | | | | | |
| Mw/Mn | 1.5 | 1.4 | 1.6 | 1.5 | 1.6 |
| Average | 3.5 | 4.6 | 4.8 | 5.1 | 6.8 |
| branching | | | | | |
| degree | | | | | |
| Residual | 400 | 1,100 | 900 | 3,000 | 2,400 |
| monomer | | | | | |
| content (ppm) | | | | | |
| Catalyst | Early | Late | Late | Late | Early |
| addition | | | | | |
| Impact | A | B | A | A | B |
| strength | | | | | |
| Bending | A | A | B | B | B |
| strength | | | | | |
| Melt viscosity | A | A | A | B | A |

TABLE 1-6-2

| | Examples | | | |
|---|---|---|---|---|
| | 6-6 | 6-7 | 6-8 | 6-9 |
| First monomer | Lactide | Lactide | Lactide | Lactide |
| Initiator | Trimethylol ethane | Castor oil | — | — |
| Second | ε-caprolactone | Mevalonolactone | Mevalonolactone | Mevalonolactone |
| monomer | | | | |
| Catalyst | Sn | Sn | Sn | Sn |
| Amount of | 5,000 | 5,000 | 5,000 | 5,000 |
| catalyst (ppm) | | | | |
| Amount of | 0.5 | 0.5 | 0.2 | 0.5 |
| initiator | | | | |
| (mol %) | | | | |
| Organic | None | None | None | Toluene 1 |
| solvent | | | | mol % |
| Temperature 1 | 100 | 150 | 150 | 150 |
| (° C.) | | | | |
| Pressure 1 | 10 | 10 | 10 | 10 |
| (Mpa) | | | | |
| Polymerization | 189 | 146 | 146 | 146 |
| density 1 | | | | |
| (kg/m³) | | | | |
| Reaction time | 0.5 | 0.5 | 0.5 | 0.5 |
| 1 (h) | | | | |
| Temperature 2 | 100 | 150 | 150 | 150 |
| (° C.) | | | | |
| Pressure 2 | 50 | 15 | 15 | 15 |
| (MPa) | | | | |
| Polymerization | 819 | 213 | 213 | 213 |
| density 2 | | | | |
| (kg/m³) | | | | |
| Reaction time | 2 | 2 | 2 | 2 |
| 2 (h) | | | | |
| R/(C + R) | 0.18 | 0.18 | 0.72 | 0.6 |
| Amount of | 15 | 12 | 9 | 13.5 |
| oxide unit | | | | |
| (mol %) | | | | |
| Weight ave. | 330,000 | 240,000 | 440,000 | 330,000 |
| molecular | | | | |
| weight | | | | |
| Mw/Mn | 1.6 | 1.7 | 1.5 | 1.7 |
| Average | 7.3 | 8.9 | 5.4 | 7.3 |
| branching | | | | |
| degree | | | | |
| Residual | 400 | 3,500 | 3,300 | 4,500 |
| monomer | | | | |
| content (ppm) | | | | |
| Catalyst | Early | Early | Late | Early |
| addition | | | | |
| Impact | B | B | B | B |
| strength | | | | |
| Bending | B | B | B | B |
| strength | | | | |
| Melt viscosity | A | A | B | B |

TABLE 1-6-3

| | Examples | | | |
|---|---|---|---|---|
| | 6-10 | 6-11 | 6-12 | 6-13 |
| First | Lactide | | | |
| monomer | | | | |
| Initiator | Castor oil | | Polyvinyl alcohol | |
| Second | Lactide/Mevalonolactone | | | |
| monomer | | | | |
| Catalyst | Sn | DBU | Sn | DBU |
| Amount of | 5,000 | 5,000 | 5,000 | 5,000 |
| catalyst (ppm) | | | | |
| Amount of | 0.5 | 0.5 | 0.5% | 0.5% |
| initiator | | | by mass | by mass |
| (mol %) | | | | |
| Organic | None | None | None | None |
| solvent | | | | |
| Temperature 1 | 150 | 60 | 150 | 60 |
| (° C.) | | | | |
| Pressure 1 | 10 | 10 | 10 | 10 |
| (Mpa) | | | | |
| Polymerization | 146 | 290 | 146 | 290 |
| density 1 | | | | |
| (kg/m³) | | | | |
| Reaction time | 0.5 | 0.5 | 0.5 | 0.5 |
| 1 (h) | | | | |
| Temperature 2 | 150 | 60 | 150 | 60 |
| (° C.) | | | | |
| Pressure 2 | 15 | 15 | 15 | 15 |
| (MPa) | | | | |
| Polymerization | 213 | 780 | 213 | 780 |
| density 2 | | | | |
| (kg/m³) | | | | |
| Reaction time | 2 | 2 | 2 | 2 |
| 2 (h) | | | | |
| R/(C + R) | 0.2 | 0.2 | 0.2 | 0.2 |
| Amount of | 13.5 | 12.5 | 14.2 | 12 |
| oxide unit | | | | |
| (mol %) | | | | |
| Weight ave. | 240,000 | 200,000 | 210,000 | 200,000 |
| molecular | | | | |
| weight | | | | |
| Mw/Mn | 1.9 | 2.1 | 1.8 | 1.9 |
| Average | 7.5 | 9.4 | 8.5 | 9.5 |
| branching | | | | |
| degree | | | | |
| Residual | 3,500 | 1,000 | 2,500 | 1,500 |
| monomer | | | | |
| content (ppm) | | | | |
| Catalyst | Late | Late | Late | Late |
| addition | | | | |
| Impact | A | B | B | B |
| strength | | | | |
| Bending | B | B | B | B |
| strength | | | | |
| Melt viscosity | B | A | A | A |

In Examples 6-12 and 6-13, a polyvinyl alcohol (MN2000 manufactured by Tokyo Chemical Industry Co., Ltd., with a saponification degree of 80%) was used as an initiator in an amount of 0.5% by mass relative to the total of monomers.

TABLE 1-7

| | Comparative Examples | | |
|---|---|---|---|
| | 1-1 | 1-2 | 1-3 |
| Monomer | Lactide | Lactide | Lactide |
| Catalyst | Sn | Sn | Sn |
| Initiator | Lauryl alcohol | Lauryl alcohol | Lauryl alcohol |
| Organic | Dichloromethane | Dichloromethane | Dichloromethane |
| solvent | | | |
| Amount of | 0.2 | 0.7 | 0.2 |
| initiator | | | |
| (mol %) | | | |
| Temperature | 25 | 25 | 25 |
| (° C.) | | | |
| Reaction time | 24 | 24 | 2 |
| (h) | | | |
| Weight ave. | 220,000 | 100,000 | 50,000 |
| molecular | | | |
| weight | | | |
| Mw/Mn | 1.6 | 1.8 | 2.0 |
| Average | 2.0 | 2.0 | 2.0 |
| branching | | | |
| degree | | | |
| Residual | 6,000 | 6,000 | 100,000 |
| monomer | | | |
| content (ppm) | | | |
| Catalyst | Late | Early | Early |
| addition | | | |
| Impact | C | C | C |
| strength | | | |
| Bending | C | C | C |
| strength | | | |
| Melt viscosity | C | C | C |

TABLE 1-8

| | Comparative Examples | | |
|---|---|---|---|
| | 1-4 | 1-5 | 1-6 |
| Monomer | Lactide | Lactide | Lactide |
| Catalyst | Sn | Sn | Sn |
| Initiator | Castor oil | Castor oil | Castor oil |
| Organic | Dichloromethane | Dichloromethane | Dichloromethane |
| solvent | | | |
| Amount of | 0.7 | 0.2 | 0.7 |
| initiator | | | |
| (mol %) | | | |
| Temperature | 25 | 25 | 25 |
| (° C.) | | | |
| Reaction time | 24 | 24 | 2 |
| (h) | | | |
| Weight ave. | 90,000 | 80,000 | 10,000 |
| molecular | | | |
| weight | | | |
| Mw/Mn | 1.9 | 1.8 | 2.1 |
| Average | 3.2 | 3.2 | 3.2 |
| branching | | | |
| degree | | | |
| Residual | 5,000 | 6,000 | 150,000 |
| monomer | | | |
| content (ppm) | | | |
| Catalyst | Early | Late | Early |
| addition | | | |
| Impact | C | C | C |
| strength | | | |
| Bending | C | C | C |
| strength | | | |

TABLE 1-9

Comparative Examples

| | 2-1 | 2-2 |
|---|---|---|
| Monomer | Lactide | Lactide |
| Catalyst | Sn | Sn |
| Initiator | Lauryl alcohol | Lauryl alcohol |
| Amount of | 0.2 | 0.7 |
| initiator | | |
| (mol %) | | |
| Temperature | 150 | 150 |
| (° C.) | | |
| Pressure | 15 | 15 |
| (Mpa) | | |
| Polymerization | 234 | 234 |
| density (kg/m³) | | |
| Reaction time | 2 | 2 |
| (h) | | |
| R/(C + R) | 0.8 | 0.8 |
| Weight ave. | 250,000 | 60,000 |
| molecular | | |
| weight | | |
| Mw/Mn | 1.7 | 1.9 |
| Average | 2.0 | 2.0 |
| branching | | |
| degree | | |
| Residual | 5,000 | 6,000 |
| monomer | | |
| content (ppm) | | |
| Catalyst | Early | Early |
| addition | | |
| Impact | C | C |
| strength | | |
| Bending | C | C |
| strength | | |
| Melt viscosity | C | C |

Descriptions in Tables 1-1-1 to 1-9 are as follows.

“Sn” represents tin octylate.

Amount of initiator (mol %) represents an amount thereof (mol %) relative to a monomer.

Amount of catalyst (ppm) represents an amount thereof (ppm) relative to a monomer.

“DBU” represents 1,8-diazabicyclo[5,4,0]undec-7-ene.

“DMAP” represents N, N-dimethyl-4-aminopyridine.

Amount of organic solvent (mol %) in the tables represents an amount thereof relative to a monomer.

Aspects of the present invention are as follows, for example.

<1> A polymer product, including

a branched chain made of polyester,

wherein the polymer product has a weight average molecular weight of 200,000 or greater when measured by gel permeation chromatography.

<2> The polymer product according to <1>,

wherein the polymer product has an average branching degree of 2.1 or greater.

<3> The polymer product according to <1> or <2>,

wherein a raw material monomer of the polymer product is a ring-opening-polymerizable cyclic ester.

<4> The polymer product according to any one of <1> to <3>,

wherein the polymer product is obtained by ring-opening-polymerizing a ring-opening-polymerizable cyclic ester using a polyhydric alcohol as an initiator.

<5> The polymer product according to any one of <1> to <4>,

wherein the polymer product has a residual monomer content of 5,000 ppm or less.

<6> The polymer product according to any one of <1> to <5>,

wherein the polymer product has a weight average molecular weight of 300,000 or greater when measured by gel permeation chromatography.

<7> A molded product,

wherein the molded product is obtained by molding the polymer product according to any one of <1> to <6>.

<8> The molded product according to <7>,

wherein the molded product is any of particles, a film, a sheet, a molded article, and a fiber.

<9> A method for producing the polymer product according to any one of <1> to <6>, including:

bringing a multifunctional initiator, a ring-opening-polymerizable monomer, and a compressive fluid into contact with one another to ring-opening-polymerize the ring-opening-polymerizable monomer.

<10> The method for producing the polymer product according to <9>, wherein the compressive fluid contains carbon dioxide.

### REFERENCE SIGNS LIST

1 tank
9 contact region
13 reaction region
21 tank
100 polymerization reaction equipment
125 addition pot
127 reaction vessel
200 polymerization reaction equipment
300 polymerization reaction equipment
400 polymerization reaction equipment
P polymer product

1. A polymer product, comprising:
a branched chain made of polyester,
wherein the polymer product has a weight average molecular weight of 200,000 or greater when measured by gel permeation chromatography.

2. The polymer product according to claim 1, wherein the polymer product has an average branching degree of 2.1 or greater.

3. The polymer product according to claim 1, wherein a raw material monomer of the polymer product is a ring-opening-polymerizable cyclic ester.

4. The polymer product according to claim 1, wherein the polymer product is obtained by ring-opening-polymerizing a ring-opening-polymerizable cyclic ester using a polyhydric alcohol as an initiator.

5. The polymer product according to claim 1, wherein the polymer product has a residual monomer content of 5,000 ppm or less.

6. The polymer product according to claim 1, wherein the polymer product has a weight average molecular weight of 300,000 or greater when measured by gel permeation chromatography.

7: A molded product, wherein the molded product is obtained by molding the polymer product according to claim 1.

8: The molded product according to claim 7, wherein the molded product is any of particles, a film, a sheet, a molded article, and a fiber.

9. A method for producing the polymer product according to claim 1, comprising:
bringing a multifunctional initiator, a ring-opening-polymerizable monomer, and a compressive fluid into contact with one another to ring-opening-polymerize the ring-opening-polymerizable monomer.

10. The method for producing the polymer product according to claim 9, wherein the compressive fluid comprises carbon dioxide.
